(19) United States
(12) Patent Application Publication
(10) Pub. No.: US 2026/0195926 A1
(43) Pub. Date: Jul. 9, 2026

(54) IMAGE DECODING METHOD, IMAGE ENCODING METHOD, IMAGE ENCODING DEVICE, AND IMAGE DECODING DEVICE USING AI

(71) Applicant: SAMSUNG ELECTRONICS CO., LTD., Suwon-si (KR)

(72) Inventors: Quockhanh DINH, Suwon-si (KR); Kwangpyo Choi, Suwon-si (KR)

(73) Assignee: SAMSUNG ELECTRONICS CO., LTD., Suwon-si (KR)

(21) Appl. No.: 19/552,696

(22) Filed: Feb. 27, 2026

Related U.S. Application Data
(63) Continuation of application No. PCT/KR2024/012546, filed on Aug. 22, 2024.

(30) Foreign Application Priority Data
Sep. 1, 2023 (KR) 10-2023-0116399
Mar. 20, 2024 (KR) 10-2024-0038473

(51) Int. Cl. G06T 9/00; G06N 3/0455

(52) U.S. Cl. CPC G06T 9/002; G06N 3/0455

(57) ABSTRACT

An image decoding method including obtaining, from a bitstream, feature data of a current optical flow and feature data of a residual image of a current image. The method including obtaining, by applying the feature data of the current optical flow to a neural network-based first decoder, the current optical flow and a plurality of remembering gate values corresponding to a plurality of resolutions of the current image. The method including obtaining a prediction image of the current image from a previous reconstructed image, based on the current optical flow. The method including obtaining a plurality of prediction tensors corresponding to the plurality of resolutions, based on the prediction image and the plurality of remembering gate values. The method including obtaining a current reconstructed image corresponding to the current image.

### CROSS-REFERENCE TO RELATED APPLICATIONS

This application is a Bypass Continuation Application of International Application PCT/KR2024/012546 filed on Aug. 22, 2024, which claims benefit of Korean Provisional Application No. 10-2023-0116399, filed on Sep. 1, 2023 filed at the Korean Intellectual Property Office, and Korean Patent Application No. 10-2024-0038478, filed on Mar. 20, 2024, filed at the Korean Intellectual Property Office, the disclosures of which are incorporated herein in their entireties by reference.

### BACKGROUND

### Field

The disclosure relates to image encoding and decoding. More particularly, the disclosure relates to a technology for encoding and decoding an image by using artificial intelligence (AI), for example, a neural network.

### Description of Related Art

Codecs such as H.264 advanced video coding (AVC) and high efficiency video coding (HEVC) may divide an image into blocks and predictively encode and decode each block through inter prediction or intra prediction.

Intra prediction is a method of compressing an image by removing spatial redundancy in the image, and inter prediction is a method of compressing an image by removing temporal redundancy between images.

A representative example of inter prediction is motion estimation coding. Motion estimation coding predicts blocks of a current image by using a reference image. A reference block that is the most similar to a current block may be found in a certain search range by using a certain evaluation function. The current block is predicted based on the reference block, and a prediction block generated as a result of prediction is subtracted from the current block to generate a residual block. The residual block is then encoded.

To derive a motion vector indicating the reference block in the reference image, a motion vector of previously encoded blocks may be used as a motion vector predictor of the current block. A differential motion vector corresponding to a difference between a motion vector of the current block and the motion vector predictor of the current block is signaled to a decoder side through a predetermined method.

Recently, techniques for encoding/decoding an image by using artificial intelligence (AI) have been proposed, and a method for effectively encoding/decoding an image using AI, for example, a neural network, is required.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

According to an embodiment of the present disclosure an image decoding method including obtaining, from a bitstream, feature data of a current optical flow and feature data of a residual image of a current image. The method including obtaining, by applying the feature data of the current optical flow to a neural network-based first decoder. The current optical flow and a plurality of remembering gate values corresponding to a plurality of resolutions of the current image. The method including obtaining a prediction image of the current image from a previous reconstructed image, based on the current optical flow. The method including obtaining a plurality of prediction tensors corresponding to the plurality of resolutions, based on the prediction image and the plurality of remembering gate values. The method including obtaining a current reconstructed image corresponding to the current image by applying the plurality of prediction tensors, the feature data of the current optical flow, and the feature data of the residual image to a neural network-based second decoder.

In an embodiment, the plurality of remembering gate values represent values for maintaining information within the current image.

In an embodiment, a plurality of forgetting gate values corresponding to the plurality of resolutions of the current image are additionally obtained from the neural network-based first decoder, the plurality of prediction tensors are obtained based on the prediction image, the plurality of remembering gate values, and the plurality of forgetting gate values, and the plurality of forgetting gate values represent values for removing, from the current image, a region in which a prediction error is equal to or greater than a preset value.

In an embodiment, a prediction tensor of an original resolution of the current image from among the plurality of prediction tensors is determined based on the prediction image and a remembering gate value corresponding to the original resolution.

In an embodiment, a prediction residual tensor is obtained based on a subtraction tensor and a forgetting gate value corresponding to the original resolution, the subtraction tensor is obtained by subtracting the prediction tensor of the original resolution of the current image from the prediction image, and a prediction tensor of a resolution downscaled from the original resolution is determined from among the plurality of prediction tensors, based on an intermediate prediction tensor of the downscaled resolution and a remembering gate value corresponding to the downscaled resolution, the intermediate prediction tensor being obtained by applying the prediction residual tensor to a downscale neural network.

In an embodiment, a prediction residual tensor is obtained based on a remembering gate value corresponding to the original resolution of the current image, a forgetting gate value corresponding to the original resolution, and the prediction image, and a prediction tensor of a resolution downscaled from the original resolution is determined from among the plurality of prediction tensors, based on an intermediate prediction tensor of the downscaled resolution and a remembering gate value corresponding to the downscaled resolution, the intermediate prediction tensor being obtained by applying the prediction residual tensor to a downscale neural network.

In an embodiment, a prediction residual tensor is obtained by subtracting the prediction tensor of the original resolution of the current image from the prediction image, a prediction tensor of a resolution downscaled from the original resolution is determined from among the plurality of prediction tensors, based on an intermediate prediction tensor of the downscaled resolution and a remembering gate value corresponding to the downscaled resolution, the intermediate prediction tensor being obtained by applying the prediction residual tensor to a downscale neural network, and a convolution kernel of a first layer of the downscale neural network is linearly mixed with a forgetting gate value corresponding to the original resolution.

In an embodiment, a prediction residual tensor of a first downscaled resolution is obtained based on a subtraction tensor and a forgetting gate value corresponding to the first downscaled resolution, the subtraction tensor being obtained by subtracting a prediction tensor of the first downscaled resolution from an intermediate prediction tensor of the first downscaled resolution before applying a remembering gate value corresponding to the first downscaled resolution to a prediction tensor of the first downscaled resolution from among the plurality of prediction tensors, and a prediction tensor of a second downscaled resolution obtained by downscaling the first downscaled resolution is determined from among the plurality of prediction tensors, based on an intermediate prediction tensor of the second downscaled resolution and a remembering gate value corresponding to the second downscaled resolution, the intermediate prediction tensor of the second downscaled resolution being obtained by applying the prediction residual tensor to a downscale neural network.

In an embodiment, a prediction residual tensor of a first downscaled resolution is obtained based on a remembering gate value corresponding to the first downscaled resolution, a forgetting gate value corresponding to the first downscaled resolution, and an intermediate prediction tensor of the first downscaled resolution before applying the remembering gate value corresponding to the first downscaled resolution to the prediction tensor of the first downscaled resolution from among the plurality of prediction tensors, and a prediction tensor of a second downscaled resolution obtained by downscaling the first downscaled resolution is determined from among the plurality of prediction tensors, based on an intermediate prediction tensor of the second downscaled resolution and a remembering gate value corresponding to the second downscaled resolution, the intermediate prediction tensor of the second downscaled resolution being obtained by applying the prediction residual tensor to a downscale neural network.

In an embodiment, a prediction residual tensor of a first downscaled resolution is obtained by subtracting a prediction tensor of the first downscaled resolution from an intermediate prediction tensor of the first downscaled resolution before applying a remembering gate value corresponding to the first downscaled resolution to a prediction tensor of the first downscaled resolution from among the plurality of prediction tensors, a prediction tensor of a second downscaled resolution obtained by downscaling the first downscaled resolution is determined from among the plurality of prediction tensors, based on an intermediate prediction tensor of the second downscaled resolution and a remembering gate value corresponding to the second downscaled resolution, the intermediate prediction tensor of the second downscaled resolution being obtained by applying the prediction residual tensor to a downscale neural network, and a convolution kernel of a first layer of the downscale neural network is linearly mixed with a forgetting gate value corresponding to the first downscaled resolution.

In an embodiment, the intermediate prediction tensor is additionally applied to the neural network-based second decoder based on a neural network to obtain the current reconstructed image.

According to an embodiment of the present disclosure, an image encoding method including obtaining feature data of a current optical flow by applying a current image and a previous reconstructed image to a neural network-based first encoder. The method including obtaining, by applying the feature data of the current optical flow to a neural network-based first decoder, the current optical flow and a plurality of remembering gate values corresponding to a plurality of resolutions of the current image. The method including obtaining a prediction image of the current image from the previous reconstructed image, based on the current optical flow. The method including obtaining a plurality of prediction tensors corresponding to the plurality of resolutions, based on the prediction image and the plurality of remembering gate values. The method including obtaining feature data of a residual image by applying the plurality of prediction tensors and the current image to a neural network-based second encoder. The method including obtaining a current reconstructed image corresponding to the current image by applying the plurality of prediction tensors, the feature data of the current optical flow, and the feature data of the residual image to a neural network-based second decoder. The method including generating a bitstream including the feature data of the current optical flow and the feature data of the residual image.

In an embodiment, the plurality of remembering gate values represent values for maintaining information within the current image.

In an embodiment, a plurality of forgetting gate values corresponding to the plurality of resolutions of the current image are additionally obtained from the neural network-based first decoder, the plurality of prediction tensors are obtained based on the prediction image, the plurality of remembering gate values, and the plurality of forgetting gate values, and the plurality of forgetting gate values represent values for removing, from the current image, a region in which a prediction error is equal to or greater than a preset value.

In an embodiment, a prediction tensor of an original resolution of the current image from among the plurality of prediction tensors is determined based on the prediction image and a remembering gate value corresponding to the original resolution.

### BRIEF DESCRIPTION OF THE DRAWINGS

FIG. 1 is a diagram illustrating an image encoding and decoding process based on AI.

FIG. 2 is a view illustrating a current optical flow, a current predicted image, and a residual image obtained from a current image and a previous reconstructed image.

FIG. 3 is a diagram for describing an image encoding and decoding process according to an embodiment of the present disclosure.

FIG. 4 is a diagram for describing a deep prediction decomposition process according to an embodiment of the present disclosure.

FIG. 5 is a diagram for describing a deep prediction decomposition process according to an embodiment of the present disclosure.

FIG. 6 is a diagram for describing a deep prediction decomposition process according to an embodiment of the present disclosure.

FIG. 7 is a diagram for describing structures of a motion encoder, a motion decoder, a multi-compensation pixel encoder, and a multi-compensation pixel decoder, according to an embodiment of the present disclosure.

FIG. 8 is a view for explaining a structure of a motion decoder according to an embodiment of the present disclosure.

FIG. 9 is a diagram for describing structures of a multi-compensation pixel encoder and a multi-compensation pixel decoder, according to an embodiment of the present disclosure.

FIG. 10 is a diagram for describing structures of a multi-compensation pixel encoder and a multi-compensation pixel decoder, according to an embodiment of the present disclosure.

FIG. 11 is a diagram for describing structures of a multi-compensation pixel encoder and a multi-compensation pixel decoder, according to an embodiment of the present disclosure.

FIG. 12 is a diagram for describing structures of a multi-compensation pixel encoder and a multi-compensation pixel decoder, according to an embodiment of the present disclosure.

FIG. 13 is a diagram for describing structures of a multi-compensation pixel encoder and a multi-compensation pixel decoder, according to an embodiment of the present disclosure.

FIG. 14 is a diagram for describing structures of a multi-compensation pixel encoder and a multi-compensation pixel decoder, according to an embodiment of the present disclosure.

FIG. 15 is a view for explaining an optical flow and a prediction error of an original frame, remembering gate values, and forgetting gate values, according to an embodiment of the present disclosure.

FIG. 16 is a flowchart of an image encoding method according to an embodiment of the present disclosure.

FIG. 17 is a block diagram of a structure of an image encoding apparatus according to an embodiment of the present disclosure.

FIG. 18 is a flowchart of an image decoding method according to an embodiment of the present disclosure.

FIG. 19 is a block diagram of a structure of an image decoding apparatus according to an embodiment of the present disclosure.

FIG. 20 is a diagram for explaining a method of training neural networks of a motion encoder, a motion decoder, a deep prediction decomposition, a multi-compensation pixel encoder, and a multi-compensation pixel decoder.

### DETAILED DESCRIPTION

As the disclosure allows for various changes and numerous embodiments, particular embodiments will be illustrated in the drawings and described in detail in the written description. However, this is not intended to limit the disclosure to particular modes of practice, and it is to be appreciated that all changes, equivalents, and substitutes that do not depart from the spirit and technical scope of the disclosure are encompassed in the disclosure.

In the description of embodiments of the disclosure, certain detailed explanations of the related art are omitted when it is deemed that they may unnecessarily obscure the essence of the disclosure. While such terms as “first,” “second,” etc., may be used to describe various components, such components must not be limited to the above terms. The above terms are used only to distinguish one component from another.

Throughout the disclosure, the expression “at least one of a, b or c” indicates only a, only b, only c, both a and b, both a and c, both b and c, all of a, b, and c, or variations thereof.

When an element (e.g., a first element) is “coupled to” or “connected to” another element (e.g., a second element), the first element may be directly coupled to or connected to the second element, or, unless otherwise described, a third element may exist therebetween.

Regarding a component represented as a “portion (unit)” or a “module” as used herein, two or more components may be combined into one component or one component may be divided into two or more components according to subdivided functions. In addition, each component described hereinafter may additionally perform some or all of functions performed by another component, in addition to main functions of itself, and some of the main functions of each component may be performed entirely by another component.

A processor may include various processing circuitry and/or a plurality of processors. For example, the term “processor” used herein, and also in the claims, may include various processing circuitry, including at least one processor. One or more processors in the at least one processor may be configured to individually and/or collectively perform the various functions described herein, in a distributed manner. As used herein, “a processor”, “at least one processor”, and “one or more processors” may be configured to perform several functions. However, these terms cover, but are not limited to, a situation where one processor performs some of the functions and other processor(s) perform others of the functions, and a situation where a single processor is capable of performing all of the functions. In addition, the at least one processor may include a combination of processors that perform various functions of the functions disclosed in a distributed manner. The at least one processor may execute program instructions in order to accomplish or perform various functions.

An ‘image’ as used herein may indicate a still image, a picture, a frame, a moving picture composed of a plurality of continuous still images, or a video.

A ‘neural network’ as used herein is a representative example of an artificial neural network model that mimics a brain nerve, and is not limited to an artificial neural network model using a specific algorithm. The neural network may also be referred to as a deep neural network.

A ‘parameter’ as used herein, which is a value used in a computation process of each layer included in a neural network, may be used, for example, when an input value is applied to a predetermined computational formula. The parameter, which is a value set as a result of training, may be updated through separate training data according to need.

‘Feature data’ as used herein refers to data obtained by processing input data by a neural-network-based encoder. The feature data may be one-dimensional or two-dimensional (1D or 2D) data including several samples. The feature data may also be referred to as latent representation. The feature data may represent latent features of data output by a decoder described below.

A ‘current image’ as used herein refers to an image to be currently processed, and a ‘previous image’ as used herein refers to an image to be processed before the current image. A ‘current motion vector’ refers to a motion vector obtained to process the current image.

A ‘sample’ used herein, which is data assigned to a sampling location in an image, a feature map, or feature data, refers to data that is to be processed. For example, the sample may include pixels in a 2D image.

In addition, in the present disclosure, the term ‘tensor’ refers to data in the form of a multi-dimensional array. The tensor may refer to image data. Also, the tensor may be data after an addition operation, a multiplication operation, or a subtraction operation, for example, has been performed on image data. Moreover, the tensor may be feature data processed through a neural network.

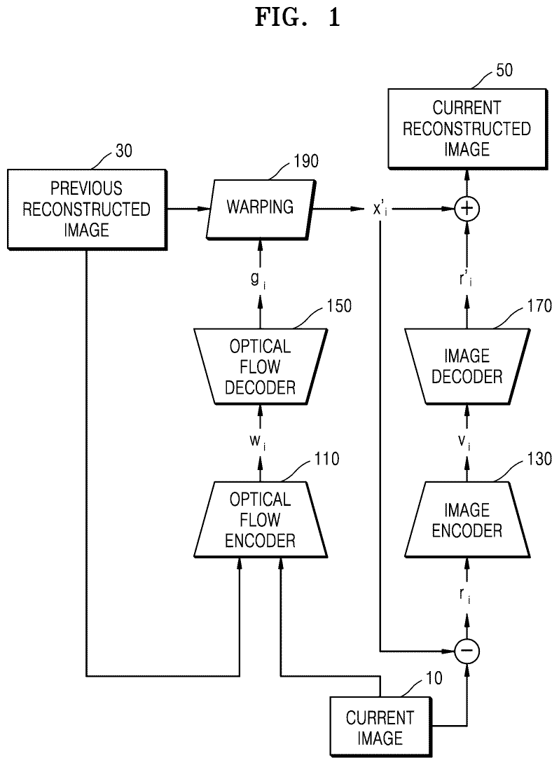

FIG. 1 is a diagram illustrating an image encoding and decoding process based on artificial intelligence (AI).

FIG. 1 illustrates an inter prediction process. In inter prediction, an optical flow encoder 110, an image encoder 130, an optical flow decoder 150, and an image decoder 170 may be used.

The optical flow encoder 110, the image encoder 130, the optical flow decoder 150, and the image decoder 170 may be implemented as neural networks.

The optical flow encoder 110 and the optical flow decoder 150 may be understood as neural networks for extracting a current optical flow gᵢ from a current image 10 and a previous reconstructed image 30.

The image encoder 130 and the image decoder 170 may be neural networks for extracting feature data of an input image (e.g., a residual image rᵢ) and reconstructing an image from the feature data.

Inter prediction is a process of encoding and decoding the current image 10 by using temporal redundancy between the current image 10 and the previous reconstructed image 30.

Position differences (or motion vectors) between blocks or samples in the current image 10 and reference blocks or reference samples in the previous reconstructed image 30 are used to encode and decode the current image 10. These position differences may be referred to as an optical flow. The optical flow may be defined as a set of motion vectors corresponding to samples or blocks in an image.

The optical flow, in particular, a current optical flow, may represent how positions of samples in the previous reconstructed image 30 have been changed in the current image 10, or where samples that are the same/similar as/to the samples of the current image 10 are located in the previous reconstructed image 30.

For example, when a sample that is the same as or the most similar to a sample located at (1, 1) in the current image 10 is located at (2, 1) in the previous reconstructed image 30, an optical flow or motion vector of the sample may be derived as (1(=2−1), 0(=1-1)).

In the image encoding and decoding process using AI, the optical flow encoder 110 and the optical flow decoder 150 may be used to obtain the current optical flow gᵢ of the current image 10.

In detail, the previous reconstructed image 30 and the current image 10 may be input to the optical flow encoder 110. The optical flow encoder 110 may output feature data wᵢ of a current optical flow by processing the current image 10 and the previous reconstructed image 30 according to parameters set as a result of training.

The feature data wᵢ of the current optical flow may be input to the optical flow decoder 150. The optical flow decoder 150 may output the current optical flow gᵢ by processing the input feature data wᵢ according to the parameters set as a result of training.

The previous reconstructed image 30 may be warped via warping 190 based on the current optical flow gᵢ, and a current predicted image x′ᵢ may be obtained as a result of the warping 190. The warping 190 is a type of geometric transformation for changing positions of samples in an image.

The current predicted image x′ᵢ similar to the current image 10 may be obtained by applying the warping 190 to the previous reconstructed image 30 according to the current optical flow gᵢ representing relative position relationships between the samples in the previous reconstructed image 30 and the samples in the current image 10.

For example, when a sample located at (1, 1) in the previous reconstructed image 30 is the most similar to a sample located at (2, 1) in the current image 10, the position of the sample located at (1, 1) in the previous reconstructed image 30 may be changed to (2, 1) through the warping 190.

Because the current predicted image x′ᵢ generated from the previous reconstructed image 30 is not the current image 10 itself, a residual image rᵢ corresponding to a difference between the current predicted image x′ᵢ and the current image 10 may be obtained. For example, the residual image rᵢ may be obtained by subtracting sample values in the current predicted image x′ᵢ from sample values in the current image 10.

The residual image rᵢ may be input to the image encoder 130. The image encoder 130 may output feature data vᵢ of the residual image rᵢ by processing the residual image rᵢ according to the parameters set as a result of training.

The feature data vᵢ of the residual image may be input to the image decoder 170. The image decoder 170 may output a reconstructed residual image r′ᵢ by processing the input feature data vᵢ according to the parameters set as a result of training.

A current reconstructed image 50 may be obtained by combining the current predicted image x′ᵢ generated by the warping 190 with respect to the previous reconstructed image 30 with the reconstructed residual image data r′ᵢ.

When the image encoding and decoding process shown in FIG. 1 is implemented by an encoding apparatus and a decoding apparatus, the encoding apparatus may quantize the feature data wᵢ of the current optical flow and the feature data vᵢ of the residual image both obtained through the encoding of the current image 10, generate a bitstream including quantized feature data, and transmit the generated bitstream to the decoding apparatus. The decoding apparatus may obtain the feature data wᵢ of the current optical flow and the feature data vᵢ of the residual image by inversely quantizing the quantized feature data extracted from the bitstream. The decoding apparatus may obtain the current reconstructed image 50 by processing the feature data wᵢ of the current optical flow and the feature data vᵢ of the residual image by using the optical flow decoder 150 and the image decoder 170.

As described above, the residual image rᵢ between the current image 10 and the current predicted image x′ᵢ may be input to the image encoder 130. Because the current prediction image x′ᵢ is generated from the previous reconstructed image 30 based on the current optical flow gᵢ, when an error exists in the current optical flow gᵢ, an error is highly likely to also exist in the current predicted image x′ᵢ and the residual image rᵢ.

When the residual image rᵢ having an error is input to the image encoder 130, the bitrate of the bitstream may unnecessarily increase. Moreover, because the current predicted image x′ᵢ having an error is combined with the reconstructed residual image r′ᵢ, the quality of the current reconstructed image 50 may also deteriorate.

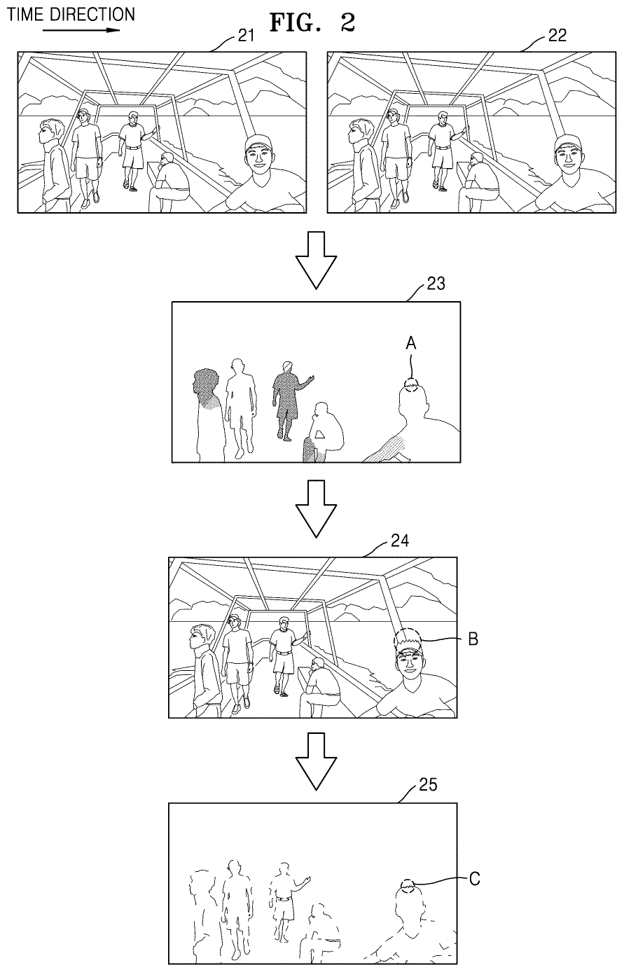

A process in which an error occurs and propagates is explained with reference to FIG. 2.

FIG. 2 is a view illustrating a current optical flow, a current predicted image, and a residual image obtained from a current image and a previous reconstructed image.

Referring to FIG. 2, a current optical flow 23 indicating the motions of samples in the current image 22 may be obtained from the current image 22 and the previous reconstructed image 21.

As described above with reference to FIG. 1, the current optical flow 23 may be obtained through the processing by the optical flow encoder 110 and the optical flow decoder 150 and the quantization and inverse quantization of the feature data of the current optical flow, and thus an error may be generated in the current optical flow 23, for example, in a region A.

Describing the causes of error occurrence in detail, first, an error may occur in the current optical flow 23 due to a limitation in the processing capabilities of the optical flow encoder 110 and the optical flow decoder 150. Because there is a limit in the computational capabilities of the encoding apparatus and the decoding apparatus, the number of layers and the size of a filter kernel of the optical flow encoder 110 and the optical flow decoder 150 may also be limited. In other words, because the optical flow encoder 110 and the optical flow decoder 150 both having limited capabilities process the current image 22 and the previous reconstructed image 21, an error may occur in the current optical flow 23.

Next, a quantization error may occur in the current optical flow 23 through quantization and inverse quantization of the feature data of the current optical flow 23. In particular, when the value of a quantization parameter is increased to increase compression efficiency, the bitrate of the bitstream decreases, but the number of quantization errors increases.

Finally, when the movement of an object included in the current image 22 and the previous reconstructed image 21 is fast, the possibility that an error occurs in the current optical flow 23 increases.

When an error exists in the region A in the current optical flow 23, an error may also occur in a region B of the current predicted image 24 generated from the previous reconstructed image 21, based on the existence of an error in the region A, and an error may also occur in a region C of the residual image 25 obtained between the current prediction image 24 and the current image 22.

Because the residual image 25 is processed by the image encoder 130 and transformed into feature data of the residual image 25, and the feature data of the residual image 25 is included in a bitstream after undergoing a preset process, it may be seen that the error present in the current optical flow 23 is delivered to the decoding apparatus.

In general, because an error has high frequency characteristics, when the residual image 25 including an error is processed by the image encoder 130, the error may cause an unnecessary increase in the bitrate of the bitstream.

An image encoding and decoding process for preventing the spread of errors existing in a current optical flow will now be described.

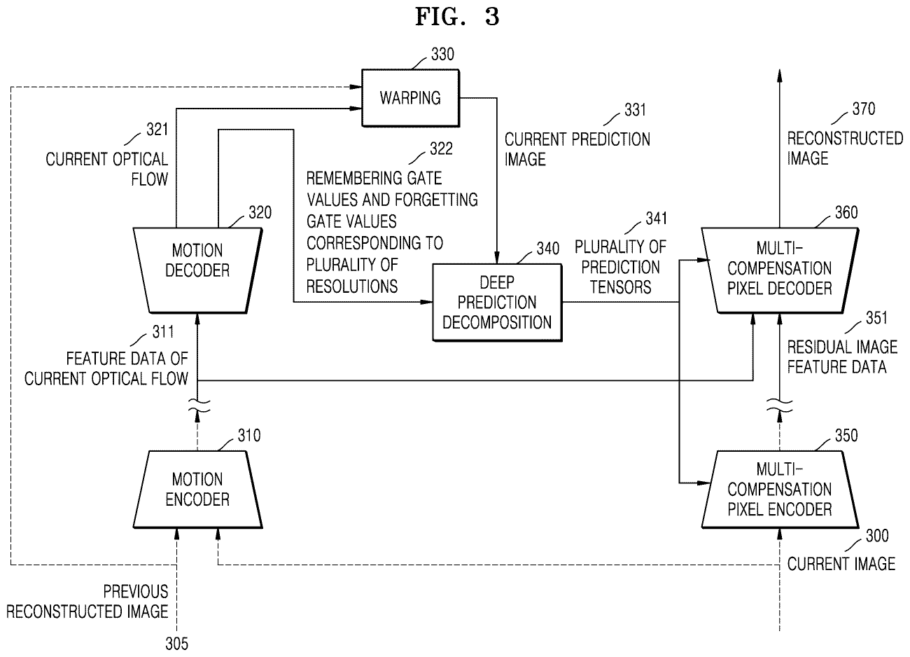

FIG. 3 is a diagram for describing an image encoding and decoding process according to an embodiment of the present disclosure.

Referring to FIG. 3, a motion encoder 310, a motion decoder 320, a multi-compensation pixel encoder 350, and a multi-compensation pixel decoder 360 may be used to encode and decode an image, and deep prediction decomposition 340 may be performed.

In the present disclosure, ‘deep prediction decomposition’ refers to a process of transforming a prediction image into a plurality of prediction images or a plurality of prediction tensors corresponding to a plurality of resolutions, based on a neural network. The plurality of resolutions include the original resolution of the predicted image and a plurality of resolutions downscaled from the original resolution.

According to an embodiment of the present disclosure, the motion encoder 310, the motion decoder 320, the multi-compensation pixel encoder 350, and the multi-compensation pixel decoder 360 may be implemented as neural networks. Also, the deep prediction decomposition 340 may also be implemented as a neural network.

To encode the current image 300, a previous reconstructed image 305 and a current image 300 may be input to the motion encoder 310. The motion encoder 310 may output feature data 311 of a current optical flow by processing the current image 300 and the previous reconstructed image 305 according to parameters set as a result of training.

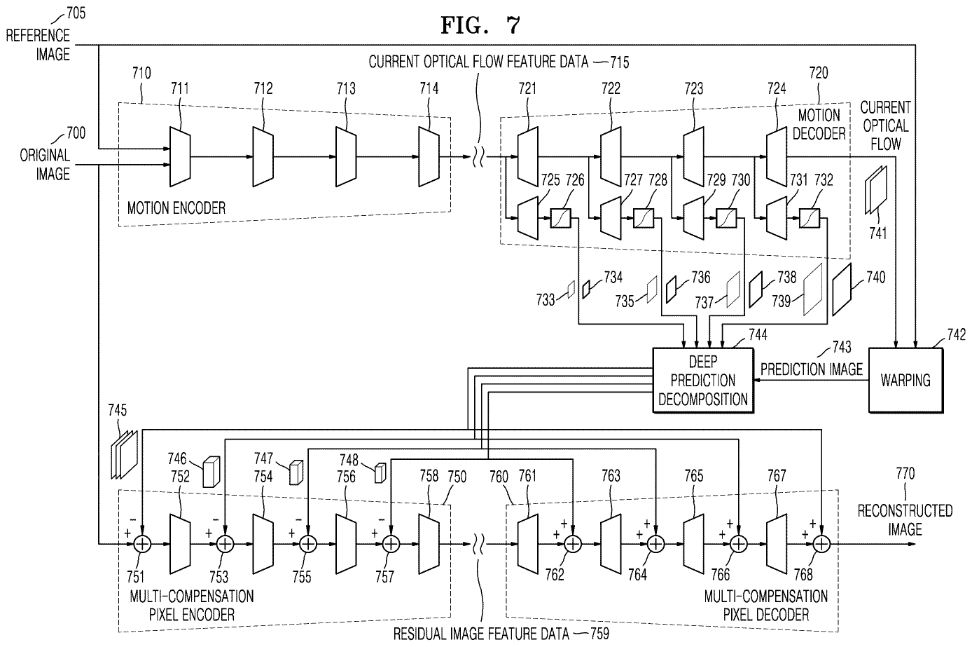

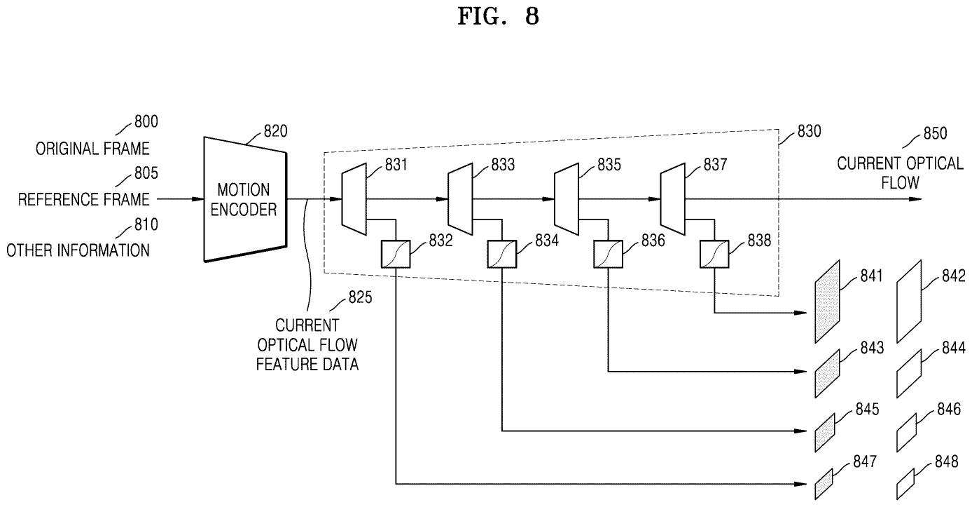

The feature data 311 of the current optical flow may be input to the motion decoder 320. The motion decoder 320 may output a decoded current optical flows 321 and remembering gate values and forgetting gate values 322 corresponding to the plurality of resolutions by processing the input feature data 311 according to the parameters set as a result of training. An exemplary structure of the motion encoder 310 and the motion decoder 320 is described below with reference to FIGS. 7 and 8.

The previous reconstructed image 305 may be warped via warping 330 based on the current optical flow 321, and a current prediction image 331 may be obtained as a result of the warping 330.

The deep prediction decomposition 340 using the remembering gate values and forgetting gate values 322 corresponding to the plurality of resolutions and the current prediction image 331 may be performed, and a plurality of prediction tensors 341 corresponding to the plurality of resolutions may be obtained as a result of the deep prediction decomposition 340. A remembering gate value represents a value for maintaining main information of an image, for example, edges or details of a well-compensated region, to retain information useful for encoding or decoding the original image, and a forgetting gate value represents a value for removing information unnecessary for encoding or decoding the original image or noise of an image, for example, edges or details of a poorly-compensated region (i.e., an occluded region or dis-occluded region). The remembering gate value and the forgetting gate value are set to values between 0 and 1. The remembering gate value represents information that is more important as it is closer to 1 and information that is less important as it is closer to 0. The closer the forgetting gate value is to 1, the more information needs to be removed, and the closer the forgetting gate value is to 0, the less information needs to be removed. The neural networks used in the deep prediction decomposition 340 may output the plurality of prediction tensors 341 by processing the current prediction image 331 according to the parameters set as a result of training. Well-predicted pixels in a prediction image are very useful for residual coding to suppress temporal redundancy, and poorly-predicted pixels in the prediction image are not useful and seriously degrade coding efficiency. Accordingly, the prediction image is decomposed into a well-predicted portion and a poorly-predicted portion, and thus, the remembering gate values are flexibly used for residual coding in the well-predicted pixels and the forgetting gate values are used for residual coding in the poorly-predicted pixels to extract pieces of information. In addition, to make the most of the prediction image, downsampling neural network layers are applied to the extracted information, for example, pieces of useful information that remain after applying forgetting gates. A plurality of pieces of useful information about the prediction image are obtained at various resolutions. That is, the prediction image is decomposed into prediction tensors of a plurality of resolutions in order to achieve better utilization of the prediction image. The prediction tensors of a plurality of resolutions are used as a reference in order to encode and decode the original image.

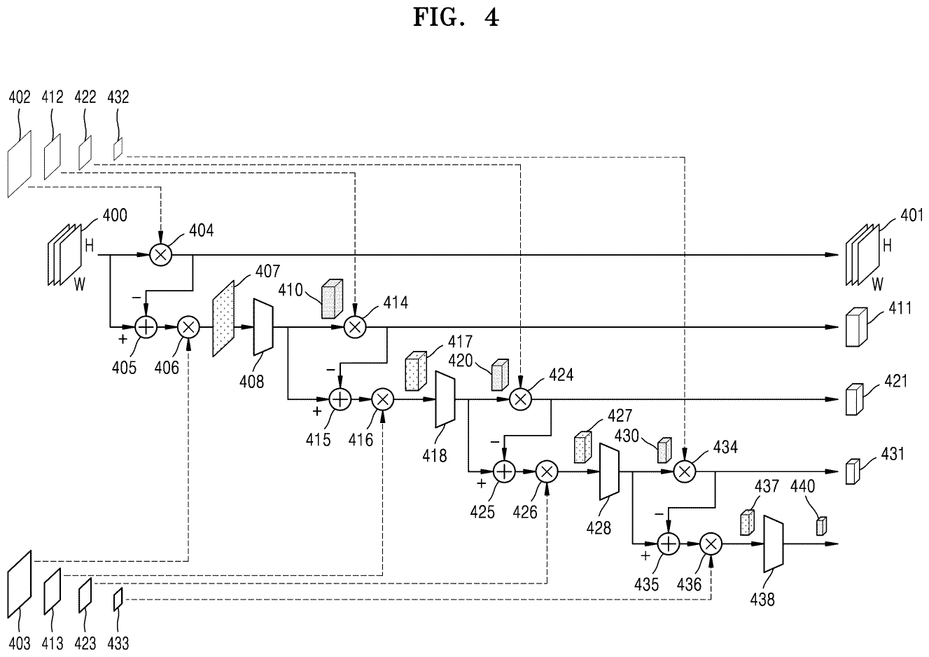

An exemplary structure of the deep prediction decomposition 340 is described below with reference to FIGS. 4 through 6.

The plurality of prediction tensors 341 and the current image 300 may be input to the multi-compensation pixel encoder 350. The multi-compensation pixel encoder 350 may output residual image feature data 351 by processing the current image 300 and the plurality of prediction tensors 341 according to the parameters set as a result of training. The residual image feature data 351 may be feature data extracted from the plurality of prediction tensors 341 and the current image 300.

The feature data 311 of the current optical flow and the residual image feature data 351 may be input to the multi-compensation pixel decoder 360. For example, a result of concatenating the feature data 311 of the current optical flow with the residual image feature data 351 may be input to the multi-compensation pixel decoder 390. The concatenation may refer to a process of combining two or more pieces of feature data in a channel direction. The plurality of prediction tensors 341 may also be input to the multi-compensation pixel decoder 360.

The multi-compensation pixel decoder 360 may obtain a reconstructed image 360 by processing the feature data 311 of the current optical flow, the residual image feature data 351, and the plurality of prediction tensors 341 according to the parameters set as a result of training.

An exemplary structure of the multi-compensation pixel encoder 350 and the multi-compensation pixel decoder 360 is described below with reference to FIG. 7 and FIGS. 9 through 14.

When the image encoding and decoding process shown in FIG. 3 is implemented by an encoding apparatus and a decoding apparatus, the encoding apparatus may generate a bitstream including the feature data 311 of the current optical flow and the residual image feature data 351 both obtained through the encoding of the current image 300, and may transmit the generated bitstream to the decoding apparatus.

The decoding apparatus may obtain the feature data 311 of the current optical flow and the residual image feature data 351 from the bitstream. The decoding apparatus may also obtain a reconstructed image 370, based on the feature data 311 of the current optical flow and the residual image feature data 351.

Changes in the image encoding and decoding process shown in FIG. 3 compared with the image encoding and decoding process shown in FIG. 1 will now be described.

Compared with the optical flow decoder 150 of FIG. 1, the motion decoder 320 of FIG. 3 additionally outputs the remembering gate values and forgetting gate values 322 corresponding to the plurality of resolutions in addition to the current optical flow 321.

In addition, in FIG. 3, the deep prediction decomposition 340 is additionally performed so that the plurality of prediction tensors 341 are obtained based on the remembering gate values and forgetting gate values 322 corresponding to the plurality of resolutions and the current prediction image 311.

The main information of the well-predicted pixels is maintained and unnecessary information of the poorly predicted pixels is removed using the remembering gate values and forgetting gate values, and, by using the prediction tensors of a plurality of resolutions through a downsampling neural network layer, pieces of remaining useful information after a forgetting gate is applied at a resolution before downscaling is utilized at a downscaled resolution, and useful information about the prediction image is obtained at various resolutions.

Also, the multi-compensation pixel encoder 350 and the multi-compensation pixel decoder 360 of FIG. 3 use, for residual coding, a plurality of prediction tensors obtained through the deep prediction decomposition 340. Accordingly, a reconstructed image is obtained in which main information of an image is maintained and unnecessary errors has been removed.

Hereinafter, an addition operation and a multiplication operation that are performed are referred to as element-wise sum and element-wise multiplication, respectively.

FIG. 4 is a diagram for describing a deep prediction decomposition process according to an embodiment of the present disclosure.

Referring to FIG. 4, a current prediction image 400 is composed of images of three channels of red, green, and blue (RGB) with a size of height (H)×width (W). Remembering gate values 402, 412, 422, and 432 corresponding to a plurality of resolutions are values corresponding to resolution sizes of H×W, H/2×W/2, H/4×W/4, and H/8×W/8, respectively. Forgetting gate values 403, 413, 423, and 433 corresponding to the plurality of resolutions are values corresponding to the resolution sizes of H×W, H/2×W/2, H/4×W/4, and H/8×W/8, respectively. The remembering gate values 402, 412, 422, and 432 and the forgetting gate values 403, 413, 423, and 433 may be a feature map of one channel that derives a spatial difference. Also, the remembering gate values 402, 412, 422, and 432 and the forgetting gate values 403, 413, 423, and 433 may be feature maps of one or more channels according to characteristics of an image.

First, a prediction tensor 401, which corresponds to the resolution of H×W and in which information of well-predicted pixels is maintained, is obtained by multiplying (as indicated by reference numeral 404) the current prediction image 400 by the remembering gate value 402 corresponding to H×W, which is the original resolution of the current prediction image 400.

A prediction residual tensor 407 corresponding to the resolution of H×W is obtained by subtracting (as indicated by reference numeral 405) the prediction tensor 401 corresponding to the resolution of H×W from the current prediction image 400 and then multiplying (as indicated by reference numeral 406) a result of the subtraction by the forgetting gate value 403 corresponding to H×W, which is the original resolution. An intermediate prediction tensor 410 corresponding to the resolution of H/2×W/2 is obtained by applying the prediction residual tensor 407 to a neural network 408. A prediction tensor 411 corresponding to the resolution of H/2×W/2 is obtained by multiplying (as indicated by reference numeral 414) the intermediate prediction tensor 410 corresponding to the resolution of H/2×W/2 by the remembering gate value 412 corresponding to the resolution of H/2×W/2.

A prediction residual tensor 417 corresponding to the resolution of H/2×W/2 is obtained by subtracting (as indicated by reference numeral 415) the prediction tensor 411 corresponding to the resolution of H/2×W/2 from the intermediate prediction tensor 410 corresponding to the resolution of H/2×W/2 and then multiplying (as indicated by reference numeral 416) a result of the subtraction by the forgetting gate value 413 corresponding to the resolution of H/2×W/2. An intermediate prediction tensor 420 corresponding to the resolution of H/4×W/4 is obtained by applying the prediction residual tensor 417 to a neural network 418. A prediction tensor 421 corresponding to the resolution of H/4×W/4 is obtained by multiplying (as indicated by reference numeral 424) the intermediate prediction tensor 420 corresponding to the resolution of H/4×W/4 by the remembering gate value 422 corresponding to the resolution of H/4×W/4.

A prediction residual tensor 427 corresponding to the resolution of H/4×W/4 is obtained by subtracting (as indicated by reference numeral 425) the prediction tensor 421 corresponding to the resolution of H/4×W/4 from the intermediate prediction tensor 420 corresponding to the resolution of H/4×W/4 and then multiplying (as indicated by reference numeral 426) a result of the subtraction by the forgetting gate value 423 corresponding to the resolution of H/4×W/4. An intermediate prediction tensor 430 corresponding to the resolution of H/8×W/8 is obtained by applying the prediction residual tensor 427 to a neural network 428. A prediction tensor 431 corresponding to the resolution of H/8×W/8 is obtained by multiplying (as indicated by reference numeral 434) the intermediate prediction tensor 430 corresponding to the resolution of H/8×W/8 by the remembering gate value 432 corresponding to the resolution of H/8×W/8.

A prediction residual tensor 437 corresponding to the resolution of H/8×W/8 is obtained by subtracting (as indicated by reference numeral 435) the prediction tensor 431 corresponding to the resolution of H/8×W/8 from the intermediate prediction tensor 430 corresponding to the resolution of H/8×W/8 and then multiplying (as indicated by reference numeral 436) a result of the subtraction by the forgetting gate value 433 corresponding to the resolution of H/8×W/8. An intermediate prediction tensor 440 corresponding to the resolution of H/16×W/16 is obtained by applying the prediction residual tensor 437 to a neural network 438.

The plurality of prediction tensors 401, 411, 421, and 431 corresponding to the four resolutions obtained through this process may be used for residual coding.

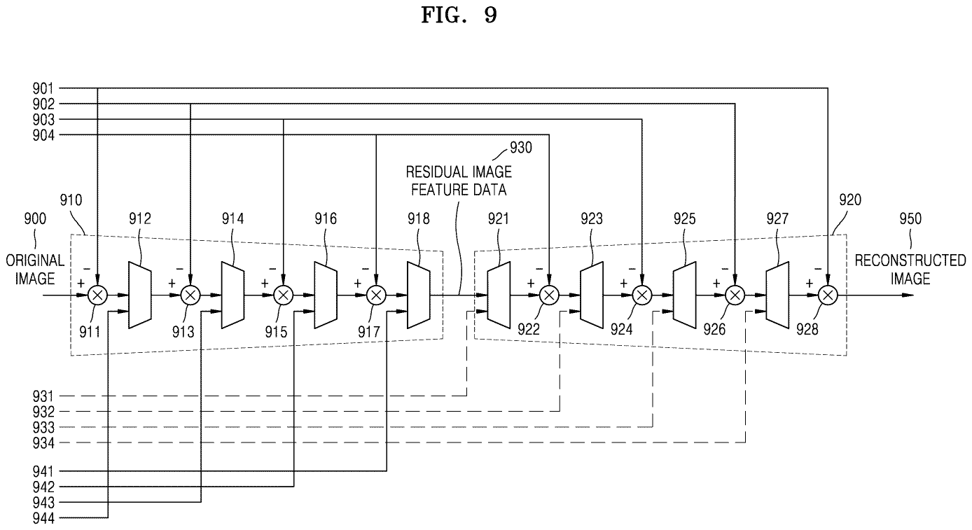

In the residual coding, the prediction residual tensor 407 corresponding to a resolution of H×W, the prediction residual tensor 417 corresponding to a resolution of H/2×W/2, the prediction residual tensor 427 corresponding to a resolution of H/4×W/4, the prediction residual tensor 437 corresponding to a resolution of H/8×W/8, the intermediate residual tensor 410 corresponding to a resolution of H/2×W/2, the intermediate residual tensor 420 corresponding to a resolution of H/4×W/4, the intermediate residual tensor 430 corresponding to a resolution of H/8×W/8, and the intermediate residual tensor 440 corresponding to a resolution of H/16×W/16 may be additionally used. This will be described later with reference to FIG. 9.

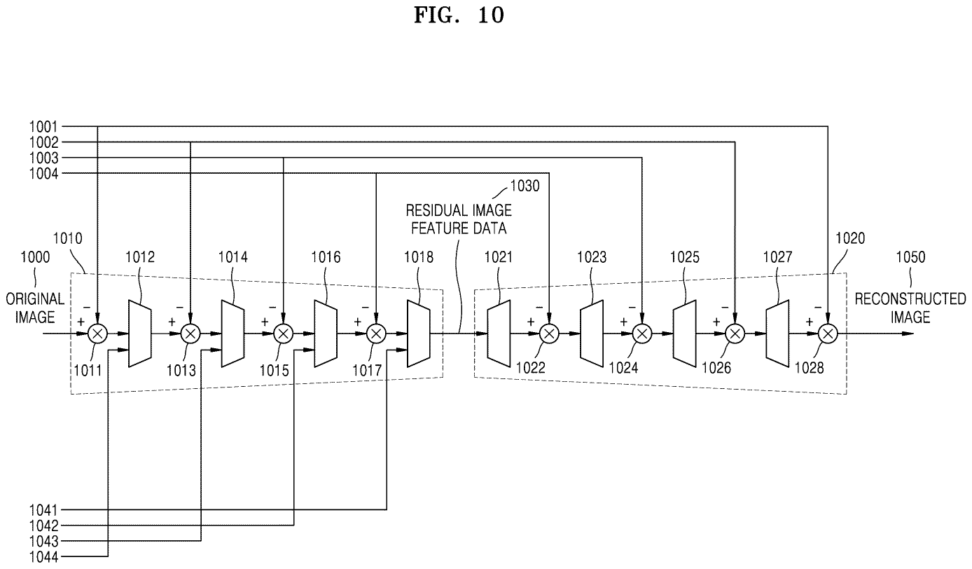

In the residual coding, the prediction residual tensor 407 corresponding to the resolution of H×W, the prediction residual tensor 417 corresponding to the resolution of H/2×W/2, the prediction residual tensor 427 corresponding to the resolution of H/4×W/2, and the prediction residual tensor 437 corresponding to the resolution of H/8×W/8 may be additionally used. This will be described later with reference to FIG. 10.

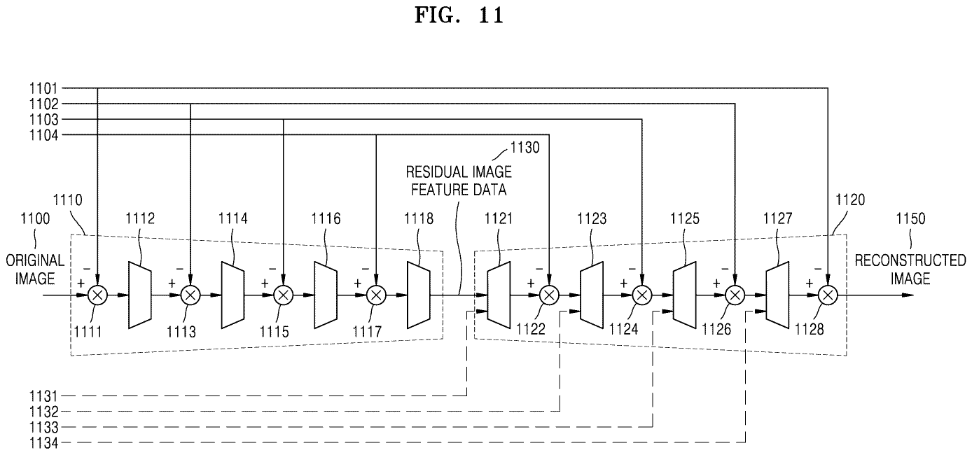

In the residual coding, the intermediate residual tensor 410 corresponding to the resolution of H/2×W/2, the intermediate residual tensor 420 corresponding to the resolution of H/4×W/4, the intermediate residual tensor 430 corresponding to the resolution of H/8×W/8, and the intermediate residual tensor 440 corresponding to the resolution of H/16×W/16 may be additionally used. This will be described later with reference to FIG. 11.

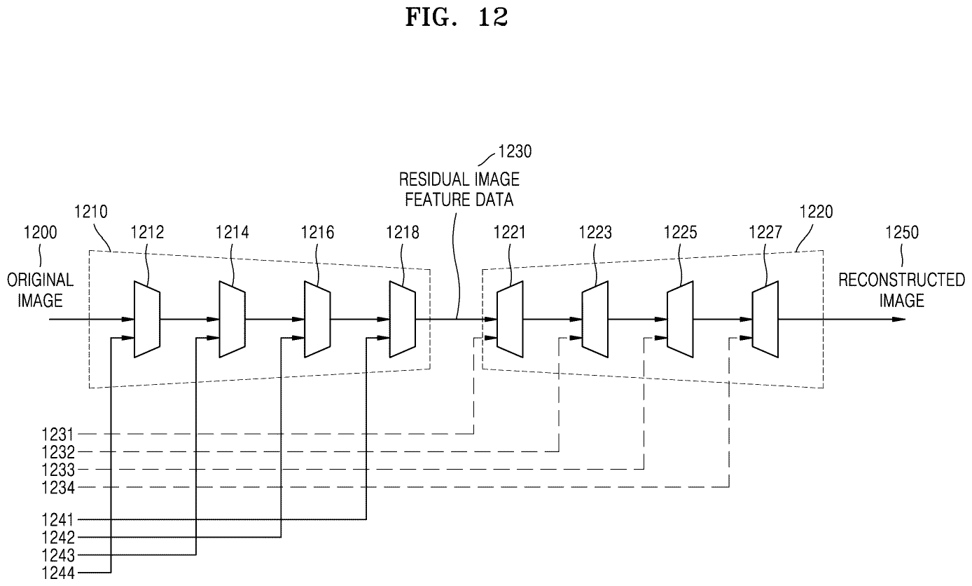

In the residual coding, the prediction residual tensor 407 corresponding to a resolution of H×W, the prediction residual tensor 417 corresponding to a resolution of H/2×W/2, the prediction residual tensor 427 corresponding to a resolution of H/4×W/4, the prediction residual tensor 437 corresponding to a resolution of H/8×W/8, the intermediate residual tensor 410 corresponding to a resolution of H/2×W/2, the intermediate residual tensor 420 corresponding to a resolution of H/4×W/4, the intermediate residual tensor 430 corresponding to a resolution of H/8×W/8, and the intermediate residual tensor 440 corresponding to a resolution of H/16×W/16 may be used instead of the plurality of prediction tensors 401, 411, 421, and 431. This will be described later with reference to FIG. 12.

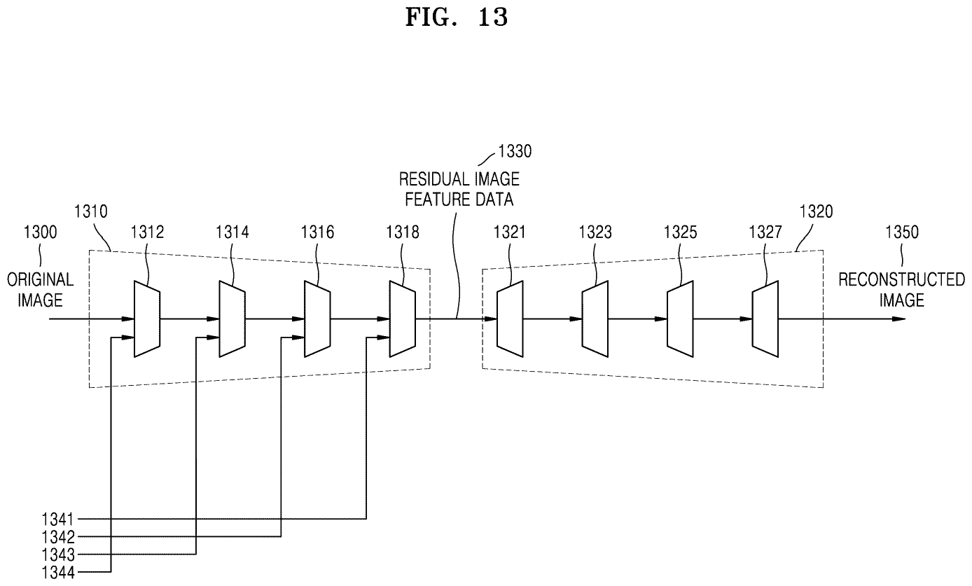

In the residual coding, the prediction residual tensor 407 corresponding to the resolution of H×W, the prediction residual tensor 417 corresponding to the resolution of H/2×W/2, the prediction residual tensor 427 corresponding to the resolution of H/4×W/4, and the prediction residual tensor 437 corresponding to the resolution of H/8×W/8 may be used instead of the plurality of prediction tensors 401, 411, 421, and 431. This will be described later with reference to FIG. 13.

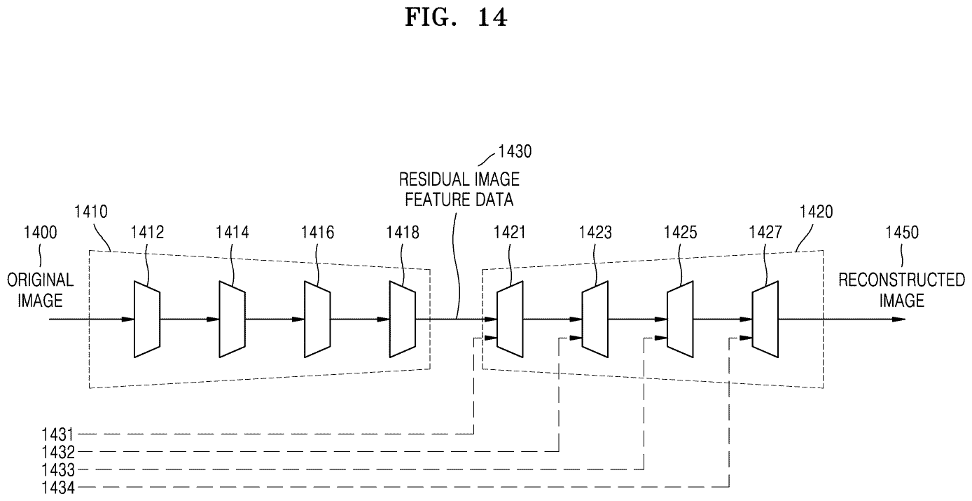

In the residual coding, the intermediate residual tensor 410 corresponding to the resolution of H/2×W/2, the intermediate residual tensor 420 corresponding to the resolution of H/4×W/4, the intermediate residual tensor 430 corresponding to the resolution of H/8×W/8, and the intermediate residual tensor 440 corresponding to the resolution of H/16×W/16 may be used instead of the plurality of prediction tensors 401, 411, 421, and 431. This will be described later with reference to FIG. 14.

Although an embodiment of the present disclosure describes prediction tensors of four resolutions, the present disclosure is not limited thereto, and prediction tensors of less than four or more than four resolutions may be obtained.

Because a plurality of prediction tensors have a lot of information at corresponding resolutions, the plurality of prediction tensors may be referred to as high-frequency data, or, because the plurality of prediction tensors include prediction information that is finally used at corresponding resolutions, the plurality of prediction tensors may be referred to as prediction data.

Because prediction residual tensors subtract, at corresponding resolutions, a tensor to which a remembering gate value has been applied from an image or tensor to which no remembering gate values are not applied, the prediction residual tensors may be referred to as residual data or residual tensors. Alternatively, because the prediction residual tensors include information available at all resolutions downscaled from the corresponding resolutions, the prediction residual tensors may be referred to as entire data or entire tensors.

Because intermediate prediction tensors are tensors of resolutions downscaled from corresponding resolutions and thus include relatively little information, the intermediate prediction tensors may be referred to as low-frequency data or low-frequency tensors. Alternatively, because the intermediate prediction tensors include remaining information that is used at downscaled resolutions, the intermediate prediction tensors may be referred to as surplus data or surplus tensors.

The prediction tensors correspond to remembering gate values of the corresponding resolutions, the prediction residual tensors correspond to forgetting gate values of the corresponding resolutions, and the intermediate prediction tensors correspond to downscaling neural networks.

A prediction tensor may be referred to as a prediction image feature map or prediction image feature data.

A prediction residual tensor may be referred to as a prediction residual image feature map or prediction residual image feature data.

An intermediate prediction tensor may be referred to as an intermediate prediction image feature map or intermediate prediction image feature data.

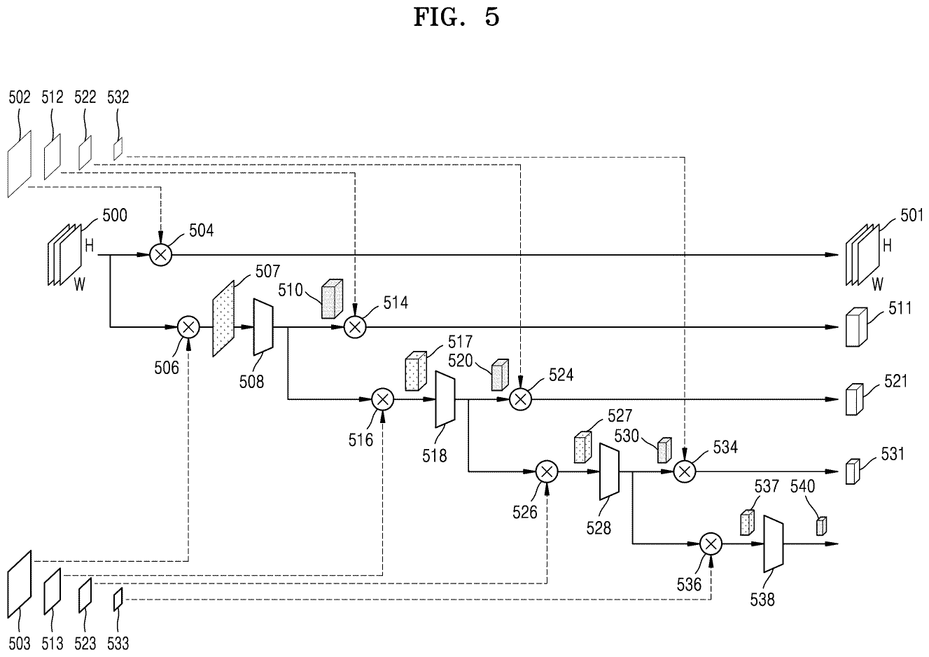

FIG. 5 is a diagram for describing a deep prediction decomposition process according to an embodiment of the present disclosure.

Referring to FIG. 5, a current prediction image 500 is composed of images of three channels of red, green, and blue (RGB) with a size of height (H)×width (W). Remembering gate values 502, 512, 522, and 532 corresponding to a plurality of resolutions are values corresponding to resolution sizes of H×W, H/2×W/2, H/4×W/4, and H/8×W/8, respectively. Forgetting gate values 503, 513, 523, and 533 corresponding to the plurality of resolutions are values corresponding to the resolution sizes of H×W, H/2×W/2, H/4×W/4, and H/8×W/8, respectively. The remembering gate values 502, 512, 522, and 532 and the forgetting gate values 503, 513, 523, and 533 may be a feature map of one channel that derives a spatial difference. Also, the remembering gate values 502, 512, 522, and 532 and the forgetting gate values 503, 513, 523, and 533 may be feature maps of one or more channels according to characteristics of an image.

When the forgetting gate values 403, 413, 423, and 433 in the embodiment of FIG. 4 are G_{f,k}, k=0, 1, 2, 3, a resolution is H/(2^{k})×W/(2^{k}), and the remembering gate values 502, 512, 522, and 532 of FIG. 5 are G_{r,k} and are the same as the remembering gate values (402, 412, 422, and 432 of FIG. 4, the forgetting gate values 503, 513, 523, and 533 of FIG. 5 become G_{f,k} (1−G_{r,k}).

First, a prediction tensor 501, which corresponds to the resolution of H×W and in which information of well-predicted pixels is maintained, is obtained by multiplying (as indicated by reference numeral 504) the current prediction image 500 by the remembering gate value 502 corresponding to H×W, which is the original resolution of the current prediction image 500.

A prediction residual tensor 507 corresponding to the resolution of H×W is obtained by multiplying (as indicated by reference numeral 506) the current prediction image 500 by the forgetting gate value 503 corresponding to H×W, which is the original resolution. An intermediate prediction tensor 510 corresponding to the resolution of H/2×W/2 is obtained by applying the prediction residual tensor 507 to a neural network 508. A prediction tensor 511 corresponding to the resolution of H/2×W/2 is obtained by multiplying (as indicated by reference numeral 514) the intermediate prediction tensor 510 corresponding to the resolution of H/2×W/2 by the remembering gate value 512 corresponding to the resolution of H/2×W/2.

A prediction residual tensor 517 corresponding to the resolution of H/2×W/2 is obtained by multiplying (as indicated by reference numeral 516) the intermediate prediction tensor 510 corresponding to the resolution of H/2×W/2 by the forgetting gate value 513 corresponding to the resolution of H/2×W/2. An intermediate prediction tensor 520 corresponding to the resolution of H/4×W/4 is obtained by applying the prediction residual tensor 517 to a neural network 518. A prediction tensor 521 corresponding to the resolution of H/4×W/4 is obtained by multiplying (as indicated by reference numeral 524) the intermediate prediction tensor 520 corresponding to the resolution of H/4×W/4 by the remembering gate value 522 corresponding to the resolution of H/4×W/4.

A prediction residual tensor 527 corresponding to the resolution of H/4×W/4 is obtained by multiplying (as indicated by reference numeral 526) the intermediate prediction tensor 520 corresponding to the resolution of H/4×W/4 by the forgetting gate value 523 corresponding to the resolution of H/4×W/4. An intermediate prediction tensor 530 corresponding to the resolution of H/8×W/8 is obtained by applying the prediction residual tensor 527 to a neural network 528. A prediction tensor 531 corresponding to the resolution of H/8×W/8 is obtained by multiplying (as indicated by reference numeral 534) the intermediate prediction tensor 530 corresponding to the resolution of H/8×W/8 by the remembering gate value 532 corresponding to the resolution of H/8×W/8.

A prediction residual tensor 537 corresponding to the resolution of H/8×W/8 is obtained by multiplying (as indicated by reference numeral 536) the intermediate prediction tensor 530 corresponding to the resolution of H/8×W/8 by the forgetting gate value 533 corresponding to the resolution of H/8×W/8. An intermediate prediction tensor 540 corresponding to the resolution of H/16×W/16 is obtained by applying the prediction residual tensor 537 to a neural network 538.

The plurality of prediction tensors 501, 511, 521, and 531 corresponding to the four resolutions obtained through this process may be used for residual coding.

Because the forgetting gate values (503, 513, 523, and 533 of FIG. 5 are obtained by multiplying values obtained by subtracting each of the remembering gate values (502, 512, 522, and 532 of FIG. 5 from 1 by the forgetting gate values 403, 413, 423, and 433 of FIG. 4, respectively, the prediction residual tensors 507, 517, 527, and 537 of FIG. 5 may be consequently identical to the prediction residual tensors 407, 417, 427, and 437 of FIG. 4, respectively.

In the residual coding, the prediction residual tensor 507 corresponding to the resolution of H×W, the prediction residual tensor 517 corresponding to the resolution of H/2×W/2, the prediction residual tensor 527 corresponding to the resolution of H/4×W/4, the prediction residual tensor 537 corresponding to the resolution of H/8×W/8, the intermediate residual tensor 510 corresponding to the resolution of H/2×W/2, the intermediate residual tensor 520 corresponding to the resolution of H/4×W/4, the intermediate residual tensor 530 corresponding to the resolution of H/8×W/8, and the intermediate residual tensor 540 corresponding to the resolution of H/16×W/16 may be additionally used. This will be described later with reference to FIG. 9.

In the residual coding, the prediction residual tensor 507 corresponding to the resolution of H×W, the prediction residual tensor 517 corresponding to the resolution of H/2×W/2, the prediction residual tensor 527 corresponding to the resolution of H/4×W/4, and the prediction residual tensor 537 corresponding to the resolution of H/8×W/8 may be additionally used. This will be described later with reference to FIG. 10.

In the residual coding, the intermediate residual tensor 510 corresponding to the resolution of H/2×W/2, the intermediate residual tensor 520 corresponding to the resolution of H/4×W/4, the intermediate residual tensor 530 corresponding to the resolution of H/8×W/8, and the intermediate residual tensor 540 corresponding to the resolution of H/16×W/16 may be additionally used. This will be described later with reference to FIG. 11.

In the residual coding, the prediction residual tensor 507 corresponding to a resolution of H×W, the prediction residual tensor 517 corresponding to a resolution of H/2×W/2, the prediction residual tensor 527 corresponding to the resolution of H/4×W/4, the prediction residual tensor 537 corresponding to the resolution of H/8×W/8, the intermediate residual tensor 510 corresponding to the resolution of H/2×W/2, the intermediate residual tensor 520 corresponding to the resolution of H/4×W/4, the intermediate residual tensor 530 corresponding to the resolution of H/8×W/8, and the intermediate residual tensor 540 corresponding to the resolution of H/16×W/16 may be used instead of the plurality of prediction tensors 501, 511, 521, and 531. This will be described later with reference to FIG. 12.

In the residual coding, the prediction residual tensor 507 corresponding to the resolution of H×W, the prediction residual tensor 517 corresponding to the resolution of H/2×W/2, the prediction residual tensor 527 corresponding to the resolution of H/4×W/2, and the prediction residual tensor 537 corresponding to the resolution of H/8×W/8 may be used instead of the plurality of prediction tensors 501, 511, 521, and 531. This will be described later with reference to FIG. 13.

In the residual coding, the intermediate residual tensor 510 corresponding to the resolution of H/2×W/2, the intermediate residual tensor 520 corresponding to the resolution of H/4×W/4, the intermediate residual tensor 530 corresponding to the resolution of H/8×W/8, and the intermediate residual tensor 540 corresponding to the resolution of H/16×W/16 may be used instead of the plurality of prediction tensors 501, 511, 521, and 531. This will be described later with reference to FIG. 14.

Although an embodiment of the present disclosure describes prediction tensors of four resolutions, the present disclosure is not limited thereto, and prediction tensors of less than four or more than four resolutions may be obtained.

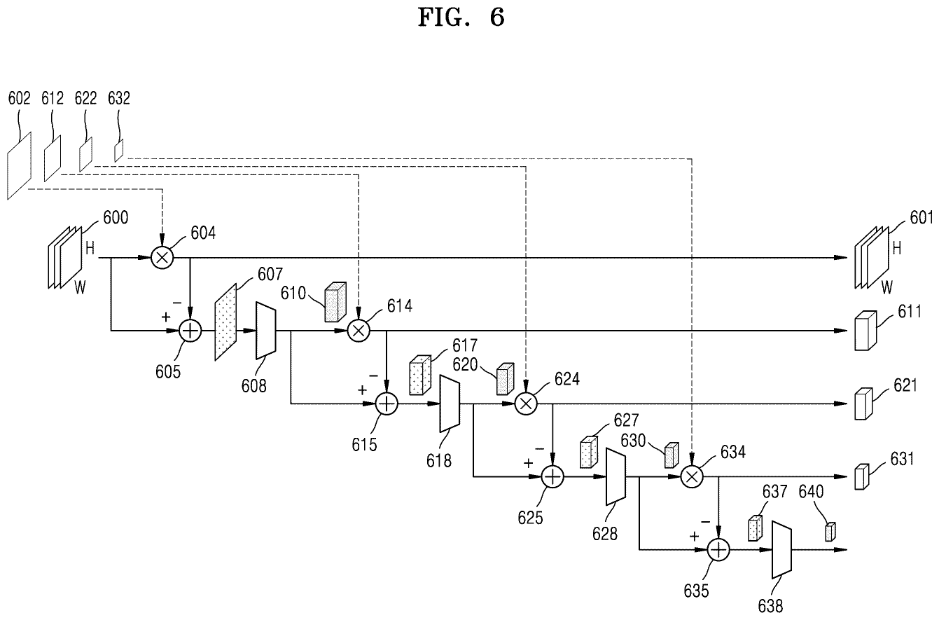

FIG. 6 is a diagram for describing a deep prediction decomposition process according to an embodiment of the present disclosure.

Referring to FIG. 6, a current prediction image 600 is composed of images of three channels of red, green, and blue (RGB) with a size of height (H)×width (W). Remembering gate values 602, 612, 622, and 632 corresponding to a plurality of resolutions are values corresponding to resolution sizes of H×W, H/2×W/2, H/4×W/4, and H/8×W/8, respectively. The remembering gate values 602, 612, 622, and 632 may be a feature map of one channel that derives a spatial difference. Also, the remembering gate values 602, 612, 622, and 632 may be feature maps of one or more channels according to characteristics of an image.

First, a prediction tensor 601, which corresponds to the resolution of H×W and in which information of well-predicted pixels is maintained, is obtained by multiplying (as indicated by reference numeral 604) the current prediction image 600 by the remembering gate value 602 corresponding to H×W, which is the original resolution of the current prediction image 600.

A prediction residual tensor 607 corresponding to the resolution of H×W is obtained by subtracting (as indicated by reference numeral 605) the prediction tensor 601 corresponding to H×W from the current prediction image 600. An intermediate prediction tensor 610 corresponding to the resolution of H/2×W/2 is obtained by applying the prediction residual tensor 607 to a neural network 608. A convolution kernel of a first layer of the neural network 608 may be linearly mixed with forgetting gate values that correspond to the resolution of H×W. Therefore, the intermediate prediction tensor 610 may be an image from which information about poorly-predicted pixels has been removed. A prediction tensor 611 corresponding to the resolution of H/2×W/2 is obtained by multiplying (as indicated by reference numeral 614) the intermediate prediction tensor 610 corresponding to the resolution of H/2×W/2 by the remembering gate value 612 corresponding to the resolution of H/2×W/2.

A prediction residual tensor 617 corresponding to the resolution of H/2×W/2 is obtained by subtracting (as indicated by reference numeral 615) the prediction tensor 611 corresponding to the resolution of H/2×W/2 from the intermediate prediction tensor 610 corresponding to the resolution of H/2×W/2. An intermediate prediction tensor 620 corresponding to the resolution of H/4×W/4 is obtained by applying the prediction residual tensor 617 to a neural network 618. A convolution kernel of a first layer of the neural network 618 may be linearly mixed with forgetting gate values that correspond to the resolution of H/2×W/2. Therefore, the intermediate prediction tensor 620 may be an image from which information about poorly-predicted pixels has been removed. A prediction tensor 621 corresponding to the resolution of H/4×W/4 is obtained by multiplying (as indicated by reference numeral 624) the intermediate prediction tensor 620 corresponding to the resolution of H/4×W/4 by the remembering gate value 622 corresponding to the resolution of H/4×W/4.

A prediction residual tensor 627 corresponding to the resolution of H/4×W/4 is obtained by subtracting (as indicated by reference numeral 625) the prediction tensor 621 corresponding to the resolution of H/4×W/4 from the intermediate prediction tensor 620 corresponding to the resolution of H/4×W/4. An intermediate prediction tensor 630 corresponding to the resolution of H/8×W/8 is obtained by applying the prediction residual tensor 627 to a neural network 628. A convolution kernel of a first layer of the neural network 628 may be linearly mixed with forgetting gate values that correspond to the resolution of H/4×W/4. Therefore, the intermediate prediction tensor 630 may be an image from which information about poorly-predicted pixels has been removed. A prediction tensor 631 corresponding to the resolution of H/8×W/8 is obtained by multiplying (as indicated by reference numeral 634) the intermediate prediction tensor 630 corresponding to the resolution of H/8×W/8 by the remembering gate value 632 corresponding to the resolution of H/8×W/8.

A prediction residual tensor 637 corresponding to the resolution of H/8×W/8 is obtained by subtracting (as indicated by reference numeral 635) the prediction tensor 631 corresponding to the resolution of H/8×W/8 from the intermediate prediction tensor 630 corresponding to the resolution of H/8×W/8. An intermediate prediction tensor 640 corresponding to the resolution of H/16×W/16 is obtained by applying the prediction residual tensor 637 to a neural network 638. A convolution kernel of a first layer of the neural network 638 may be linearly mixed with forgetting gate values that linearly correspond to the resolution of H/8×W/8. Therefore, the intermediate prediction tensor 630 may be an image from which information about poorly-predicted pixels has been removed.

The plurality of prediction tensors 601, 611, 621, and 631 corresponding to the four resolutions obtained through this process may be used for residual coding.

Because the convolution kernels of the respective first layers of the neural networks 608, 618, 628, and 638 of FIG. 6 are mixed with forgetting gate values corresponding to respective resolutions, the prediction residual tensors 607, 617, 627, and 637 of FIG. 6 may be consequently identical to the prediction residual tensors 407, 417, 427, and 437 of FIG. 4, respectively.

In the residual coding, the prediction residual tensor 607 corresponding to the resolution of H×W, the prediction residual tensor 617 corresponding to the resolution of H/2×W/2, the prediction residual tensor 627 corresponding to the resolution of H/4×W/4, the prediction residual tensor 637 corresponding to the resolution of H/8×W/8, the intermediate residual tensor 610 corresponding to the resolution of H/2×W/2, the intermediate residual tensor 620 corresponding to the resolution of H/4×W/4, the intermediate residual tensor 630 corresponding to the resolution of H/8×W/8, and the intermediate residual tensor 640 corresponding to the resolution of H/16×W/16 may be additionally used. This will be described later with reference to FIG. 9.

In the residual coding, the prediction residual tensor 607 corresponding to the resolution of H×W, the prediction residual tensor 617 corresponding to the resolution of H/2×W/2, the prediction residual tensor 627 corresponding to the resolution of H/4×W/4, and the prediction residual tensor 637 corresponding to the resolution of H/8×W/8 may be additionally used. This will be described later with reference to FIG. 10.

In the residual coding, the intermediate residual tensor 610 corresponding to the resolution of H/2×W/2, the intermediate residual tensor 620 corresponding to the resolution of H/4×W/4, the intermediate residual tensor 630 corresponding to the resolution of H/8×W/8, and the intermediate residual tensor 640 corresponding to the resolution of H/16×W/16 may be additionally used. This will be described later with reference to FIG. 11.

In the residual coding, the prediction residual tensor 607 corresponding to a resolution of H×W, the prediction residual tensor 617 corresponding to a resolution of H/2×W/2, the prediction residual tensor 627 corresponding to a resolution of H/4×W/4, the prediction residual tensor 637 corresponding to a resolution of H/8×W/8, the intermediate residual tensor 610 corresponding to a resolution of H/2×W/2, the intermediate residual tensor 620 corresponding to a resolution of H/4×W/4, the intermediate residual tensor 630 corresponding to a resolution of H/8×W/8, and the intermediate residual tensor 640 corresponding to a resolution of H/16×W/16 may be used instead of the plurality of prediction tensors 601, 611, 621, and 631. This will be described later with reference to FIG. 12.

In the residual coding, the prediction residual tensor 607 corresponding to the resolution of H×W, the prediction residual tensor 617 corresponding to the resolution of H/2×W/2, the prediction residual tensor 627 corresponding to the resolution of H/4×W/4, and the prediction residual tensor 637 corresponding to the resolution of H/8×W/8 may be used instead of the plurality of prediction tensors 601, 611, 621, and 631. This will be described later with reference to FIG. 13.

In the residual coding, the intermediate residual tensor 610 corresponding to the resolution of H/2×W/2, the intermediate residual tensor 620 corresponding to the resolution of H/4×W/4, the intermediate residual tensor 630 corresponding to the resolution of H/8×W/8, and the intermediate residual tensor 640 corresponding to the resolution of H/16×W/16 may be used instead of the plurality of prediction tensors 601, 611, 621, and 631. This will be described later with reference to FIG. 14.

Although an embodiment of the present disclosure describes prediction tensors of four resolutions, the present disclosure is not limited thereto, and prediction tensors of less than four or more than four resolutions may be obtained.

FIG. 7 is a diagram for describing structures of a motion encoder, a motion decoder, a multi-compensation pixel encoder, and a multi-compensation pixel decoder according to an embodiment of the present disclosure.

Referring to FIG. 7, a reference image 705, which is a previous reconstructed image, and an original image 700 are input to a motion encoder 710. Feature data 715 for a current optical flow is sequentially downscaled through a plurality of neural networks 711, 712, 713, and 714 within the motion encoder 710 and output. Each of the plurality of neural networks 711, 712, 713, and 714 within the motion encoder 710 may include at least one convolutional layer. In addition, the plurality of neural networks 711, 712, 713, and 714 may downscale input data and output a result of the downscaling.

The feature data 715 for a current optical flow output by the motion encoder 710 is input to a motion decoder 720. The feature data 715 of the current optical flow is input to a network 721, and thus first intermediate data is obtained. In addition, the feature data 715 for a current optical flow is input to a convolutional layer 725 and a sigmoid function 726 to obtain a remembering gate value 733 of a first resolution and a forgetting gate value 734 of the first resolution. The sigmoid function, which is one of activation functions used in neural networks, is a nonlinear function that outputs input data as a value between 0 and 1. Therefore, remembering gate values and forgetting gate values obtained through the sigmoid function are values between 0 and 1. The first intermediate data is input into a neural network 722, and thus second intermediate data is obtained. In addition, the first intermediate data is input to a convolutional layer 727 and a sigmoid function 728 to obtain a remembering gate value 735 of a second resolution and a forgetting gate value 736 of the second resolution. The second intermediate data is input into a neural network 723, and thus third intermediate data is obtained. In addition, the second intermediate data is input to a convolutional layer 729 and a sigmoid function 730 to obtain a remembering gate value 737 of a third resolution and a forgetting gate value 738 of the third resolution. The third intermediate data is input into a neural network 724, and thus a current optical flow is obtained. In addition, the third intermediate data is input to a convolutional layer 731 and a sigmoid function 732 to obtain a remembering gate value 739 of a fourth resolution and a forgetting gate value 740 of the fourth resolution. For example, the fourth resolution may correspond to a resolution of the original image, the third resolution may correspond to ½ the resolution of the original resolution, the second resolution may correspond to ¼ the resolution of the original resolution, and the first resolution may correspond to ⅛ the resolution of the original resolution. Each of the neural networks 721, 722, 723, and 724 within the motion decoder 720 may include at least one convolutional layer. In addition, the neural networks 721, 722, 723, and 724 may upscale input data. In addition, the convolutional layers 725, 727, 729, and 731 within the motion decoder 720 may upscale input data.

A prediction image 743 for a current image is obtained by warping (as indicated by reference numeral 742) a current optical flow 741 and the reference image 705.

Prediction tensors 745, 746, 747, and 748 corresponding to a plurality of resolutions are obtained through deep prediction decomposition 744 by using the remembering gate values 733, 735, 737, and 739 corresponding to a plurality of resolutions, forgetting gate values 734, 736, 738, and 740 corresponding to a plurality of resolutions, and the prediction image 743. The deep prediction decomposition 744 has been described above with reference to FIGS. 4 through 6, so a description thereof will be omitted.

In a multi-compensation pixel encoder 750, first, a first subtraction tensor obtained by subtracting (as indicated by reference numeral 751) the prediction tensor 745 of a fourth resolution corresponding to the original resolution from the original image 700 is input to a neural network 752. An intermediate encoding tensor of a third resolution is output through the neural network 752. A second subtraction tensor obtained by subtracting (as indicated by reference numeral 753) a prediction tensor 746 of the third resolution from the intermediate encoding tensor of the third resolution is input to a neural network 754. An intermediate encoding tensor of a second resolution is output through the neural network 754. A third subtraction tensor obtained by subtracting (as indicated by reference numeral 755) a prediction tensor 747 of a second resolution from the intermediate encoding tensor of the second resolution is input to a neural network 756. An intermediate encoding tensor of a first resolution is output through the neural network 754. A fourth subtraction tensor obtained by subtracting (as indicated by reference numeral 757) a prediction tensor 748 of a first resolution from the intermediate encoding tensor of the first resolution is input to a neural network 758. Residual image feature data 759 is output through the neural network 758. Each of the plurality of neural networks 752, 754, 756, and 758 within the multi-compensation pixel encoder 750 may include at least one convolutional layer. In addition, the plurality of neural networks 752, 754, 756, and 758 may downscale input data and output a result of the downscaling.

In a multi-compensation pixel decoder 760, first, the residual image feature data 759 is input to a neural network 761. A residual tensor of a first resolution is obtained through the neural network 761. The residual tensor of a first resolution is summed (as indicated by reference numeral 762) with the prediction tensor 748 of a first resolution and is input to a neural network 763. A residual tensor of a second resolution is obtained through the neural network 763. The residual tensor of a second resolution is summed (as indicated by reference numeral 764) with the prediction tensor 747 of a second resolution and is input to a neural network 765. A residual tensor of a third resolution is obtained through the neural network 765.

The residual tensor of a third resolution is summed (as indicated by reference numeral 766) with the prediction tensor 746 of a third resolution and is input to a neural network 767. A residual tensor of a first resolution is obtained through the neural network 767. The residual tensor of a first resolution is summed (as indicated by reference numeral 768) with the prediction tensor 745 of a first resolution. A reconstructed image 770 is output as a result of the summation 768. Each of the neural networks 761, 763, 765, and 767 within the multi-compensation pixel decoder 760 may include at least one convolutional layer. In addition, the neural networks 761, 763, 765, and 767 may upscale input data.

Additionally, the multi-compensation pixel decoder 760 may also receive the feature data 715 of the current optical flow in addition to the residual image feature data 759. The residual image feature data 759 and the feature data 715 of the current optical flow may be concatenated with each other and may be input.

The multi-compensation pixel encoder 750 and the multi-compensation pixel decoder 760 sequentially perform residual coding several times according to a plurality of resolutions in a pixel domain.

FIG. 8 is a view for explaining a structure of a motion decoder according to an embodiment of the present disclosure.

Referring to FIG. 8, an original frame 800 and a reference frame 805 are input to a motion encoder 820. Other information 810 about a current image may be additionally input to the motion encoder 820. Feature data 825 of a current optical flow is output by the motion encoder 820. A structure of the motion encoder 820 may be the same as that of the motion encoder 710 described above with reference to FIG. 7.

The feature data 825 of the current optical flow is input to a neural network 831 of a motion decoder 830. First intermediate data and first gate data are obtained from the neural network 831. The first intermediate data is applied to a sigmoid function 832 to obtain a remembering gate value 847 of a first resolution and a forgetting gate value 848 of the first resolution. The first intermediate data is input into a neural network 833. Second intermediate data and second gate data are obtained from the neural network 833. The second intermediate data is applied to a sigmoid function 834 to obtain a remembering gate value 845 of a second resolution and a forgetting gate value 846 of the second resolution. The second intermediate data is input into a neural network 835. Third intermediate data and third gate data are obtained from the neural network 835. The third intermediate data is applied to a sigmoid function 836 to obtain a remembering gate value 843 of a third resolution and a forgetting gate value 844 of the third resolution. The third intermediate data is input into a neural network 837. A current optical flow 850 and fourth intermediate data are obtained from the neural network 837. The fourth intermediate data is applied to a sigmoid function 838 to obtain a remembering gate value 841 of a fourth resolution and a forgetting gate value 842 of the fourth resolution. For example, the fourth resolution may correspond to a resolution of the original image, the third resolution may correspond to ½ the resolution of the original resolution, the second resolution may correspond to ¼ the resolution of the original resolution, and the first resolution may correspond to ⅛ the resolution of the original resolution. Each of the neural networks 831, 833, 835, and 837 within the motion decoder 830 may include at least one convolutional layer. In addition, the neural networks 831, 833, 835, and 837 may upscale input data.

Because the motion decoder 720 of FIG. 7 and the motion decoder 830 of FIG. 8 output a current optical flow, remembering gate values, and forgetting gate values based on the feature data 715 and 825 of the current optical flow, the motion decoder 720 of FIG. 7 and the motion decoder 830 of FIG. 8 may be referred to as a multi-purpose motion decoder. That is, optical flow encoding and decoding and gate generation may be efficiently merged with each other. In addition, the motion encoder 710 of FIG. 7 and the motion encoder 820 of FIG. 8 corresponding thereto may be referred to as a multi-purpose motion encoder. The remembering gate values and the forgetting gate values may also be referred to as a decomposition gate or a decomposition weight.

According to an embodiment of the present disclosure, the remembering gate values and the forgetting gate values may be generated independently from respective encoders and decoders, rather than being output based on a motion encoder and a motion decoder. For example, an original image and a reference image may be input to a remembering gate encoder, remembering gate feature data may be output by the remembering gate encoder, remembering gate feature data may be input to a remembering gate decoder, and remembering gate values corresponding to a plurality of resolutions may be output by the remembering gate decoder. In addition, an original image and a reference image may be input to a forgetting gate encoder, forgetting gate feature data may be output by the forgetting gate encoder, forgetting gate feature data may be input to a forgetting gate decoder, and forgetting gate values corresponding to a plurality of resolutions may be output by the forgetting gate decoder.

FIG. 9 is a diagram for describing structures of a multi-compensation pixel encoder and a multi-compensation pixel decoder according to an embodiment of the present disclosure.

Referring to FIG. 9, in a multi-compensation pixel encoder 910, first, a first subtraction tensor obtained by subtracting (as indicated by reference numeral 911) a prediction tensor 901 of the original resolution from an original image 900, and a prediction residual tensor 944 of the original resolution are input to a neural network 912. The first subtraction tensor and the prediction residual tensor 944 may be concatenated with each other and input. The prediction residual tensor 944 of the original resolution corresponds to the prediction residual tensor 407 of FIG. 4, the prediction residual tensor 507 of FIG. 5, or the prediction residual tensor 607 of FIG. 6.

An intermediate encoding tensor of a first downscaled resolution obtained by downscaling the original resolution is output through the neural network 912. A second subtraction tensor obtained by subtracting (as indicated by reference numeral 913) a prediction tensor 902 of the first downscaled resolution from the intermediate encoding tensor of the first downscaled resolution, and a prediction residual tensor 943 of the first downscaled resolution are input to a neural network 914. The second subtraction tensor and the prediction residual tensor 943 may be concatenated with each other and input. The prediction residual tensor 943 of the first downscaled resolution corresponds to the prediction residual tensor 417 of FIG. 4, the prediction residual tensor 517 of FIG. 5, or the prediction residual tensor 617 of FIG. 6.

An intermediate encoding tensor of a second downscaled resolution obtained by downscaling the first downscaled resolution is output through the neural network 914. A third subtraction tensor obtained by subtracting (as indicated by reference numeral 915) a prediction tensor 903 of the second downscaled resolution from the intermediate encoding tensor of the second downscaled resolution, and a prediction residual tensor 942 of the second downscaled resolution are input to a neural network 916. The third subtraction tensor and the prediction residual tensor 942 may be concatenated with each other and input. The prediction residual tensor 942 of the second downscaled resolution corresponds to the prediction residual tensor 427 of FIG. 4, the prediction residual tensor 527 of FIG. 5, or the prediction residual tensor 627 of FIG. 6.

An intermediate encoding tensor of a third downscaled resolution obtained by downscaling the second downscaled resolution is output through the neural network 916. A fourth subtraction tensor obtained by subtracting (as indicated by reference numeral 917) a prediction tensor 904 of the third downscaled resolution from the intermediate encoding tensor of the third downscaled resolution, and a prediction residual tensor 941 of the third downscaled resolution are input to a neural network 918. The fourth subtraction tensor and the prediction residual tensor 941 may be concatenated with each other and input. The prediction residual tensor 941 of the third downscaled resolution corresponds to the prediction residual tensor 437 of FIG. 4, the prediction residual tensor 537 of FIG. 5, or the prediction residual tensor 637 of FIG. 6.

Residual image feature data 930 is output through the neural network 918. Each of the plurality of neural networks 912, 914, 916, and 918 within the multi-compensation pixel encoder 910 may include at least one convolutional layer. In addition, the plurality of neural networks 912, 914, 916, and 918 may downscale input data and output a result of the downscaling.

In a multi-compensation pixel decoder 920, first, an intermediate prediction tensor 931 of a fourth downscaled resolution obtained by downscaling the third downscaled resolution, and the residual image feature data 930 are input to a neural network 921. The residual image feature data 930 and the intermediate prediction tensor 931 may be concatenated with each other and may be input. The intermediate prediction tensor 931 of the fourth downscaled resolution corresponds to the intermediate prediction tensor 440 of FIG. 4, the intermediate prediction tensor 540 of FIG. 5, or the intermediate prediction tensor 640 of FIG. 6.

A residual tensor of the third downscaled resolution is obtained through the neural network 921. The residual tensor of the third downscaled resolution is summed (as indicated by reference numeral 922) with the prediction tensor 904 of the third downscaled resolution and is input to a neural network 923. In addition, an intermediate prediction tensor 932 of the third downscaled resolution is also input to the neural network 923. Data corresponding to a result of the summation 922, and the intermediate prediction tensor 932 may be concatenated with each other and input. The intermediate prediction tensor 932 of the third downscaled resolution corresponds to the intermediate prediction tensor 430 of FIG. 4, the intermediate prediction tensor 530 of FIG. 5, or the intermediate prediction tensor 630 of FIG. 6.

A residual tensor of the second downscaled resolution is obtained through the neural network 923. The residual tensor of the second downscaled resolution is summed (as indicated by reference numeral 924) with the prediction tensor 903 of the second downscaled resolution and is input to a neural network 925. In addition, an intermediate prediction tensor 933 of the second downscaled resolution is also input to the neural network 925. Data corresponding to a result of the summation 924, and the intermediate prediction tensor 933 may be concatenated with each other and input. The intermediate prediction tensor 933 of the second downscaled resolution corresponds to the intermediate prediction tensor 420 of FIG. 4, the intermediate prediction tensor 520 of FIG. 5, or the intermediate prediction tensor 620 of FIG. 6.

A residual tensor of the first downscaled resolution is obtained through the neural network 925. The residual tensor of the first downscaled resolution is summed (as indicated by reference numeral 926) with the prediction tensor 902 of the first downscaled resolution and is input to a neural network 927. In addition, an intermediate prediction tensor 934 of the first downscaled resolution is also input to the neural network 927. Data corresponding to a result of the summation 926, and the intermediate prediction tensor 934 may be concatenated with each other and input. The intermediate prediction tensor 934 of the first downscaled resolution corresponds to the intermediate prediction tensor 410 of FIG. 4, the intermediate prediction tensor 510 of FIG. 5, or the intermediate prediction tensor 610 of FIG. 6.

A residual tensor of the original resolution is obtained through the neural network 927. The residual tensor of the original resolution is summed (as indicated by reference numeral 928) with the prediction tensor 901 of the original resolution. A reconstructed image 950 is output as a result of the summation 928.

Each of the neural networks 921, 923, 925, and 927 within the multi-compensation pixel decoder 920 may include at least one convolutional layer. In addition, the neural networks 921, 923, 925, and 927 may upscale input data.

The prediction tensors 901, 902, 903, and 904 correspond to the prediction tensors 401, 402, 403, and 404 of FIG. 4, the prediction tensors 501, 502, 503, and 504 of FIG. 5, or the prediction tensors 601, 602, 603, and 604 of FIG. 6.

In addition, the multi-compensation pixel decoder 920 may also receive feature data of a current optical flow in addition to the residual image feature data 930. The residual image feature data 930 and the feature data of the current optical flow may be concatenated with each other and may be input.

FIG. 10 is a diagram for describing structures of a multi-compensation pixel encoder and a multi-compensation pixel decoder according to an embodiment of the present disclosure.

Referring to FIG. 10, in a multi-compensation pixel encoder 1010, first, a first subtraction tensor obtained by subtracting (as indicated by reference numeral 1011) a prediction tensor 1001 of the original resolution from an original image 1000, and a prediction residual tensor 1044 of the original resolution are input to a neural network 1012. The first subtraction tensor and the prediction residual tensor 1044 may be concatenated with each other and input. The prediction residual tensor 1044 of the original resolution corresponds to the prediction residual tensor 407 of FIG. 4, the prediction residual tensor 507 of FIG. 5, or the prediction residual tensor 607 of FIG. 6.

An intermediate encoding tensor of a first downscaled resolution obtained by downscaling the original resolution is output through the neural network 1012. A second subtraction tensor obtained by subtracting (as indicated by reference numeral 1013) a prediction tensor 1002 of the first downscaled resolution from the intermediate encoding tensor of the first downscaled resolution, and a prediction residual tensor 1043 of the first downscaled resolution are input to a neural network 1014. The second subtraction tensor and the prediction residual tensor 1043 may be concatenated with each other and input. The prediction residual tensor 1043 of the first downscaled resolution corresponds to the prediction residual tensor 417 of FIG. 4, the prediction residual tensor 517 of FIG. 5, or the prediction residual tensor 617 of FIG. 6.

An intermediate encoding tensor of a second downscaled resolution obtained by downscaling the first downscaled resolution is output through the neural network 1014. A third subtraction tensor obtained by subtracting (as indicated by reference numeral 1015) a prediction tensor 1003 of the second downscaled resolution from the intermediate encoding tensor of the second downscaled resolution, and a prediction residual tensor 1042 of the second downscaled resolution are input to a neural network 1016. The third subtraction tensor and the prediction residual tensor 1042 may be concatenated with each other and input. The prediction residual tensor 1042 of the second downscaled resolution corresponds to the prediction residual tensor 427 of FIG. 4, the prediction residual tensor 527 of FIG. 5, or the prediction residual tensor 627 of FIG. 6.

An intermediate encoding tensor of a third downscaled resolution obtained by downscaling the second downscaled resolution is output through the neural network 1016. A fourth subtraction tensor obtained by subtracting (as indicated by reference numeral 1017) a prediction tensor 1004 of the third downscaled resolution from the intermediate encoding tensor of the third downscaled resolution, and a prediction residual tensor 1041 of the third downscaled resolution are input to a neural network 1018. The fourth subtraction tensor and the prediction residual tensor 1041 may be concatenated with each other and input. The prediction residual tensor 1041 of the third downscaled resolution corresponds to the prediction residual tensor 437 of FIG. 4, the prediction residual tensor 537 of FIG. 5, or the prediction residual tensor 637 of FIG. 6.

Residual image feature data 1030 is output through the neural network 1018. Each of the plurality of neural networks 1012, 1014, 1016, and 1018 within the multi-compensation pixel encoder 1010 may include at least one convolutional layer. In addition, the plurality of neural networks 1012, 1014, 1016, and 1018 may downscale input data and output a result of the downscaling.

In a multi-compensation pixel decoder 1020, first, the residual image feature data 1030 is input to a neural network 1021.

A residual tensor of the third downscaled resolution is obtained through the neural network 1021. The residual tensor of the third downscaled resolution is summed (as indicated by reference numeral 1022) with the prediction tensor 1004 of the third downscaled resolution and is input to a neural network 1023.

A residual tensor of the second downscaled resolution is obtained through the neural network 1023. The residual tensor of the second downscaled resolution is summed (as indicated by reference numeral 1024) with the prediction tensor 1003 of the second downscaled resolution and is input to a neural network 1025.

A residual tensor of the first downscaled resolution is obtained through the neural network 1025. The residual tensor of the first downscaled resolution is summed (as indicated by reference numeral 1026) with the prediction tensor 1002 of the first downscaled resolution and is input to a neural network 1027.

A residual tensor of the original resolution is obtained through the neural network 1027. The residual tensor of the original resolution is summed (as indicated by reference numeral 1028) with the prediction tensor 1001 of the original resolution. A reconstructed image 1050 is output as a result of the summation 1028.

Each of the neural networks 1021, 1023, 1025, and 1027 within the multi-compensation pixel decoder 1020 may include at least one convolutional layer. In addition, the neural networks 1021, 1023, 1025, and 1027 may upscale input data.

The prediction tensors 1001, 1002, 1003, and 1004 correspond to the prediction tensors 401, 402, 403, and 404 of FIG. 4, the prediction tensors 501, 502, 503, and 504 of FIG. 5, or the prediction tensors 601, 602, 603, and 604 of FIG. 6.

In addition, the multi-compensation pixel decoder 1020 may also receive feature data of a current optical flow in addition to the residual image feature data 1030. The residual image feature data 1030 and the feature data of the current optical flow may be concatenated with each other and may be input.

FIG. 11 is a diagram for describing structures of a multi-compensation pixel encoder and a multi-compensation pixel decoder according to an embodiment of the present disclosure.

Referring to FIG. 11, in a multi-compensation pixel encoder 1110, first, a first subtraction tensor obtained by subtracting (as indicated by reference numeral 1111) a prediction tensor 1101 of the original resolution from an original image 1100 is input to a neural network 1112.

An intermediate encoding tensor of a first downscaled resolution obtained by downscaling the original resolution is output through the neural network 1112. A second subtraction tensor obtained by subtracting (as indicated by reference numeral 1113) a prediction tensor 1102 of the first downscaled resolution from the intermediate encoding tensor of the first downscaled resolution is input to a neural network 1114.

An intermediate encoding tensor of a second downscaled resolution obtained by downscaling the first downscaled resolution is output through the neural network 1114. A third subtraction tensor obtained by subtracting (as indicated by reference numeral 1115) a prediction tensor 1103 of a second downscaled resolution from the intermediate encoding tensor of the second downscaled resolution is input to a neural network 1116.

An intermediate encoding tensor of a third downscaled resolution obtained by downscaling the second downscaled resolution is output through the neural network 1116. A fourth subtraction tensor obtained by subtracting (as indicated by reference numeral 1117) a prediction tensor 1104 of the third downscaled resolution from the intermediate encoding tensor of the third downscaled resolution is input to a neural network 1118.

Residual image feature data 1130 is output through the neural network 1118. Each of the plurality of neural networks 1112, 1114, 1116, and 1118 within the multi-compensation pixel encoder 1110 may include at least one convolutional layer. In addition, the plurality of neural networks 1112, 1114, 1116, and 1118 may downscale input data and output a result of the downscaling.

In a multi-compensation pixel decoder 1120, first, an intermediate prediction tensor 1131 of a fourth downscaled resolution obtained by downscaling the third downscaled resolution, and the residual image feature data 1130 are input to a neural network 1121. The residual image feature data 1130 and the intermediate prediction tensor 1131 may be concatenated with each other and may be input. The intermediate prediction tensor 1131 of the fourth downscaled resolution corresponds to the intermediate prediction tensor 440 of FIG. 4, the intermediate prediction tensor 540 of FIG. 5, or the intermediate prediction tensor 640 of FIG. 6.

A residual tensor of the third downscaled resolution is obtained through the neural network 1121. The residual tensor of the third downscaled resolution is summed (as indicated by reference numeral 1122) with the prediction tensor 1104 of the third downscaled resolution and is input to a neural network 1123. In addition, an intermediate prediction tensor 1132 of the third downscaled resolution is also input to the neural network 1123. Data corresponding to a result of the summation 1122, and the intermediate prediction tensor 1132 may be concatenated with each other and input. The intermediate prediction tensor 1132 of the third downscaled resolution corresponds to the intermediate prediction tensor 430 of FIG. 4, the intermediate prediction tensor 530 of FIG. 5, or the intermediate prediction tensor 630 of FIG. 6.

A residual tensor of the second downscaled resolution is obtained through the neural network 1123. The residual tensor of the second downscaled resolution is summed (as indicated by reference numeral 1124) with the prediction tensor 1103 of the second downscaled resolution and is input to a neural network 1125. In addition, an intermediate prediction tensor 1133 of the second downscaled resolution is also input to the neural network 1125. Data corresponding to a result of the summation 1124, and the intermediate prediction tensor 1133 may be concatenated with each other and input. The intermediate prediction tensor 1133 of the second downscaled resolution corresponds to the intermediate prediction tensor 420 of FIG. 4, the intermediate prediction tensor 520 of FIG. 5, or the intermediate prediction tensor 620 of FIG. 6.

A residual tensor of the first downscaled resolution is obtained through the neural network 1125. The residual tensor of the first downscaled resolution is summed (as indicated by reference numeral 1126) with the prediction tensor 1102 of the first downscaled resolution and is input to a neural network 1127. In addition, an intermediate prediction tensor 1134 of the first downscaled resolution is also input to the neural network 1127. Data corresponding to a result of the summation 1126, and the intermediate prediction tensor 1134 may be concatenated with each other and input. The intermediate prediction tensor 1134 of the first downscaled resolution corresponds to the intermediate prediction tensor 410 of FIG. 4, the intermediate prediction tensor 510 of FIG. 5, or the intermediate prediction tensor 610 of FIG. 6.

A residual tensor of the original resolution is obtained through the neural network 1127. The residual tensor of the original resolution is summed (as indicated by reference numeral 1128) with the prediction tensor 1101 of the original resolution. A reconstructed image 1150 is output as a result of the summation 1128.

Each of the neural networks 1121, 1123, 1125, and 1127 within the multi-compensation pixel decoder 1120 may include at least one convolutional layer. In addition, the neural networks 1121, 1123, 1125, and 1127 may upscale input data.

The prediction tensors 1101, 1102, 1103, and 1104 correspond to the prediction tensors 401, 402, 403, and 404 of FIG. 4, the prediction tensors 501, 502, 503, and 504 of FIG. 5, or the prediction tensors 601, 602, 603, and 604 of FIG. 6.

In addition, the multi-compensation pixel decoder 1120 may also receive feature data of a current optical flow in addition to the residual image feature data 1130. The residual image feature data 1130 and the feature data of the current optical flow may be concatenated with each other and may be input.

FIG. 12 is a diagram for describing structures of a multi-compensation pixel encoder and a multi-compensation pixel decoder according to an embodiment of the present disclosure.

Referring to FIG. 12, in a multi-compensation pixel encoder 1210, first, an original image 1200 and a prediction residual tensor 1244 of the original resolution are input to a neural network 1212. The original image 1200 and the prediction residual tensor 1244 may be concatenated with each other and input. The prediction residual tensor 1244 of the original resolution corresponds to the prediction residual tensor 407 of FIG. 4, the prediction residual tensor 507 of FIG. 5, or the prediction residual tensor 607 of FIG. 6.

An intermediate encoding tensor of a first downscaled resolution obtained by downscaling the original resolution is output through the neural network 1212. The intermediate encoding tensor of the first downscaled resolution and a prediction residual tensor 1243 of the first downscaled resolution are input to a neural network 1214. The intermediate encoding tensor of the first downscaled resolution and the prediction residual tensor 1243 may be concatenated with each other and input. The prediction residual tensor 1243 of the first downscaled resolution corresponds to the prediction residual tensor 417 of FIG. 4, the prediction residual tensor 517 of FIG. 5, or the prediction residual tensor 617 of FIG. 6.

An intermediate encoding tensor of a second downscaled resolution obtained by downscaling the first downscaled resolution is output through the neural network 1214. The intermediate encoding tensor of the second downscaled resolution and a prediction residual tensor 1242 of the second downscaled resolution are input to a neural network 1216. The intermediate encoding tensor of the second downscaled resolution and the prediction residual tensor 1242 may be concatenated with each other and input. The prediction residual tensor 1242 of the second downscaled resolution corresponds to the prediction residual tensor 427 of FIG. 4, the prediction residual tensor 527 of FIG. 5, or the prediction residual tensor 627 of FIG. 6.

An intermediate encoding tensor of a third downscaled resolution obtained by downscaling the second downscaled resolution is output through the neural network 1216. The intermediate encoding tensor of the third downscaled resolution and a prediction residual tensor 1241 of the third downscaled resolution are input to a neural network 1218. The intermediate encoding tensor of the third downscaled resolution and the prediction residual tensor 1241 may be concatenated with each other and input. The prediction residual tensor 1241 of the third downscaled resolution corresponds to the prediction residual tensor 437 of FIG. 4, the prediction residual tensor 537 of FIG. 5, or the prediction residual tensor 637 of FIG. 6.

Residual image feature data 1230 is output through the neural network 1218. Each of the plurality of neural networks 1212, 1214, 1216, and 1218 within the multi-compensation pixel encoder 1210 may include at least one convolutional layer. In addition, the plurality of neural networks 1212, 1214, 1216, and 1218 may downscale input data and output a result of the downscaling.

In a multi-compensation pixel decoder 1220, first, an intermediate prediction tensor 1231 of a fourth downscaled resolution obtained by downscaling the third downscaled resolution, and the residual image feature data 1230 are input to a neural network 1221. The residual image feature data 1230 and the intermediate prediction tensor 1231 may be concatenated with each other and may be input. The intermediate prediction tensor 1231 of the fourth downscaled resolution corresponds to the intermediate prediction tensor 440 of FIG. 4, the intermediate prediction tensor 540 of FIG. 5, or the intermediate prediction tensor 640 of FIG. 6.

A residual tensor of the third downscaled resolution is obtained through the neural network 1221. The residual tensor of the third downscaled resolution and an intermediate prediction tensor 1232 of the third downscaled resolution are input to a neural network 1223. The residual tensor of the third downscaled resolution and the intermediate prediction tensor 1232 may be concatenated with each other and input. The intermediate prediction tensor 1232 of the third downscaled resolution corresponds to the intermediate prediction tensor 430 of FIG. 4, the intermediate prediction tensor 530 of FIG. 5, or the intermediate prediction tensor 630 of FIG. 6.

A residual tensor of the second downscaled resolution is obtained through the neural network 1223. The residual tensor of the second downscaled resolution and an intermediate prediction tensor 1233 of the second downscaled resolution are input to a neural network 1225. The residual tensor of the second downscaled resolution and the intermediate prediction tensor 1233 may be concatenated with each other and input. The intermediate prediction tensor 1233 of the second downscaled resolution corresponds to the intermediate prediction tensor 420 of FIG. 4, the intermediate prediction tensor 520 of FIG. 5, or the intermediate prediction tensor 620 of FIG. 6.

A residual tensor of the first downscaled resolution is obtained through the neural network 1225. The residual tensor of the first downscaled resolution and an intermediate prediction tensor 1234 of the first downscaled resolution are input to a neural network 1227. The residual tensor of the first downscaled resolution and the intermediate prediction tensor 1234 may be concatenated with each other and input. The intermediate prediction tensor 1234 of the first downscaled resolution corresponds to the intermediate prediction tensor 410 of FIG. 4, the intermediate prediction tensor 510 of FIG. 5, or the intermediate prediction tensor 610 of FIG. 6.

A reconstructed image 1250 of the original resolution is output through the neural network 1227.

Each of the neural networks 1221, 1223, 1225, and 1227 within the multi-compensation pixel decoder 1220 may include at least one convolutional layer. In addition, the neural networks 1221, 1223, 1225, and 1227 may upscale input data.

In addition, the multi-compensation pixel decoder 1220 may also receive feature data of a current optical flow in addition to the residual image feature data 1230. The residual image feature data 1230 and the feature data of the current optical flow may be concatenated with each other and may be input.

FIG. 13 is a diagram for describing structures of a multi-compensation pixel encoder and a multi-compensation pixel decoder according to an embodiment of the present disclosure.

Referring to FIG. 13, in a multi-compensation pixel encoder 1310, first, an original image 1300 and a prediction residual tensor 1344 of the original resolution are input to a neural network 1312. The original image 1300 and the prediction residual tensor 1344 may be concatenated with each other and input. The prediction residual tensor 1344 of the original resolution corresponds to the prediction residual tensor 407 of FIG. 4, the prediction residual tensor 507 of FIG. 5, or the prediction residual tensor 607 of FIG. 6.

An intermediate encoding tensor of a first downscaled resolution obtained by downscaling the original resolution is output through the neural network 1312. The intermediate encoding tensor of the first downscaled resolution and a prediction residual tensor 1343 of the first downscaled resolution are input to a neural network 1314. The intermediate encoding tensor of the first downscaled resolution and the prediction residual tensor 1343 may be concatenated with each other and input. The prediction residual tensor 1343 of the first downscaled resolution corresponds to the prediction residual tensor 417 of FIG. 4, the prediction residual tensor 517 of FIG. 5, or the prediction residual tensor 617 of FIG. 6.

An intermediate encoding tensor of a second downscaled resolution obtained by downscaling the first downscaled resolution is output through the neural network 1314. The intermediate encoding tensor of the second downscaled resolution and a prediction residual tensor 1342 of the second downscaled resolution are input to a neural network 1316. The intermediate encoding tensor of the second downscaled resolution and the prediction residual tensor 1342 may be concatenated with each other and input. The prediction residual tensor 1342 of the second downscaled resolution corresponds to the prediction residual tensor 427 of FIG. 4, the prediction residual tensor 527 of FIG. 5, or the prediction residual tensor 627 of FIG. 6.

An intermediate encoding tensor of a third downscaled resolution obtained by downscaling the second downscaled resolution is output through the neural network 1316. The intermediate encoding tensor of the third downscaled resolution and a prediction residual tensor 1341 of the third downscaled resolution are input to a neural network 1318. The intermediate encoding tensor of the third downscaled resolution and the prediction residual tensor 1341 may be concatenated with each other and input. The prediction residual tensor 1341 of the third downscaled resolution corresponds to the prediction residual tensor 437 of FIG. 4, the prediction residual tensor 537 of FIG. 5, or the prediction residual tensor 637 of FIG. 6.

Residual image feature data 1330 is output through the neural network 1318. Each of the plurality of neural networks 1312, 1314, 1316, and 1318 within the multi-compensation pixel encoder 1310 may include at least one convolutional layer. In addition, the plurality of neural networks 1312, 1314, 1316, and 1318 may downscale input data and output a result of the downscaling.

In the multi-compensation pixel decoder 1320, the residual image feature data 1330 is output as a reconstructed image 1350 of the original resolution through a plurality of neural networks 1321, 1323, 1325, and 1327.

Each of the neural networks 1321, 1323, 1325, and 1327 within the multi-compensation pixel decoder 1320 may include at least one convolutional layer. In addition, the neural networks 1321, 1323, 1325, and 1327 may upscale input data.

In addition, the multi-compensation pixel decoder 1320 may also receive feature data of a current optical flow in addition to the residual image feature data 1330. The residual image feature data 1330 and the feature data of the current optical flow may be concatenated with each other and may be input.

FIG. 14 is a diagram for describing structures of a multi-compensation pixel encoder and a multi-compensation pixel decoder according to an embodiment of the present disclosure.

Referring to FIG. 14, in a multi-compensation pixel encoder 1410, an original image 1400 is output as residual image feature data 1430 through a plurality of neural networks 1412, 1414, 1416, and 1418.

Each of the plurality of neural networks 1412, 1414, 1416, and 1418 within the multi-compensation pixel encoder 1410 may include at least one convolutional layer. In addition, the plurality of neural networks 1412, 1414, 1416, and 1418 may downscale input data and output a result of the downscaling.

In a multi-compensation pixel decoder 1420, first, an intermediate prediction tensor 1431 of a fourth downscaled resolution obtained by downscaling a third downscaled resolution, and the residual image feature data 1430 are input to a neural network 1421. The residual image feature data 1430 and the intermediate prediction tensor 1431 may be concatenated with each other and may be input. The intermediate prediction tensor 1431 of the fourth downscaled resolution corresponds to the intermediate prediction tensor 440 of FIG. 4, the intermediate prediction tensor 540 of FIG. 5, or the intermediate prediction tensor 640 of FIG. 6.

A residual tensor of the third downscaled resolution is obtained through the neural network 1421. The residual tensor of the third downscaled resolution and an intermediate prediction tensor 1432 of the third downscaled resolution are input to a neural network 1423. The residual tensor of the third downscaled resolution and the intermediate prediction tensor 1432 may be concatenated with each other and input. The intermediate prediction tensor 1432 of the third downscaled resolution corresponds to the intermediate prediction tensor 430 of FIG. 4, the intermediate prediction tensor 530 of FIG. 5, or the intermediate prediction tensor 630 of FIG. 6.

A residual tensor of the second downscaled resolution is obtained through the neural network 1423. The residual tensor of the second downscaled resolution and an intermediate prediction tensor 1433 of the second downscaled resolution are input to a neural network 1425. The residual tensor of the second downscaled resolution and the intermediate prediction tensor 1433 may be concatenated with each other and input. The intermediate prediction tensor 1433 of the second downscaled resolution corresponds to the intermediate prediction tensor 420 of FIG. 4, the intermediate prediction tensor 520 of FIG. 5, or the intermediate prediction tensor 620 of FIG. 6.

A residual tensor of the first downscaled resolution is obtained through the neural network 1425. The residual tensor of the first downscaled resolution and an intermediate prediction tensor 1434 of the first downscaled resolution are input to a neural network 1427. The residual tensor of the first downscaled resolution and the intermediate prediction tensor 1434 may be concatenated with each other and input. The intermediate prediction tensor 1434 of the first downscaled resolution corresponds to the intermediate prediction tensor 410 of FIG. 4, the intermediate prediction tensor 510 of FIG. 5, or the intermediate prediction tensor 610 of FIG. 6.

A reconstructed image 1450 of the original resolution is output through the neural network 1427.

Each of the neural networks 1421, 1423, 1425, and 1427 within the multi-compensation pixel decoder 1420 may include at least one convolutional layer. In addition, the neural networks 1421, 1423, 1425, and 1427 may upscale input data.

In addition, the multi-compensation pixel decoder 1420 may also receive feature data of a current optical flow in addition to the residual image feature data 1430. The residual image feature data 1430 and the feature data of the current optical flow may be concatenated with each other and may be input.

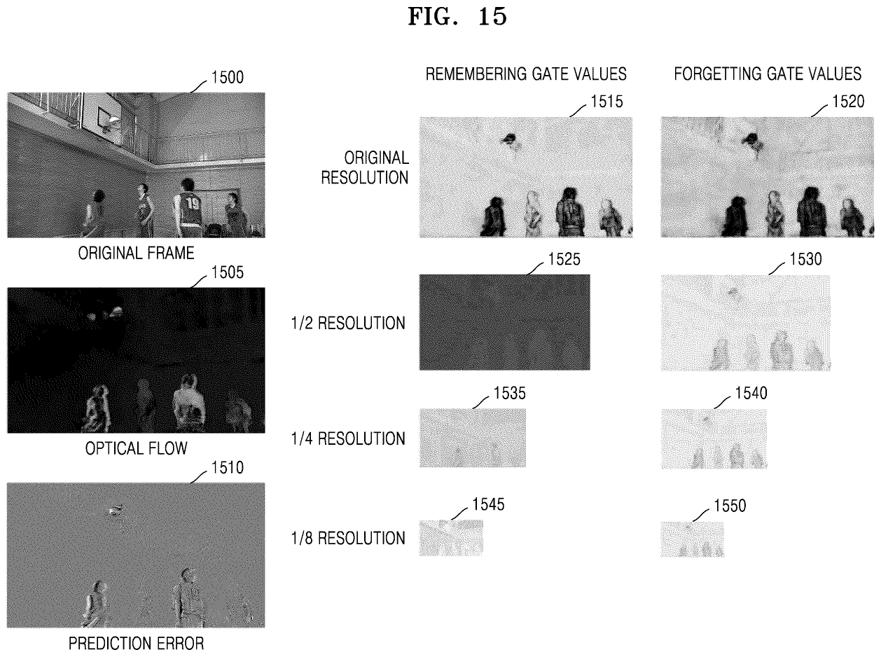

FIG. 15 is a view for explaining an optical flow and a prediction error of an original frame, remembering gate values, and forgetting gate values, according to an embodiment of the present disclosure.

Referring to FIG. 15, a prediction frame for an original frame 1500 may be obtained based on an optical flow 1505 of the original frame 1500, and a prediction error 1510 may occur between the original frame 1500 and the prediction frame.

To prevent the prediction error 1510, remembering gate values 1515, 1525, 1535, and 1545 and forgetting gate values 1520, 1530, 1540, and 1550 are used.

In a region where the prediction error 1510 occurs, a well-predicted portion needs to be maintained, and a poorly-predicted portion needs to be removed. Accordingly, the remembering gate values 1515, 1525, 1535, and 1545 have relatively large values for a portion having information that needs to be maintained from among portions where prediction errors have occurred, and the forgetting gate values 1520, 1530, 1540, and 1550 have relatively large values for a portion that needs to be removed from among the portions where prediction errors have occurred.

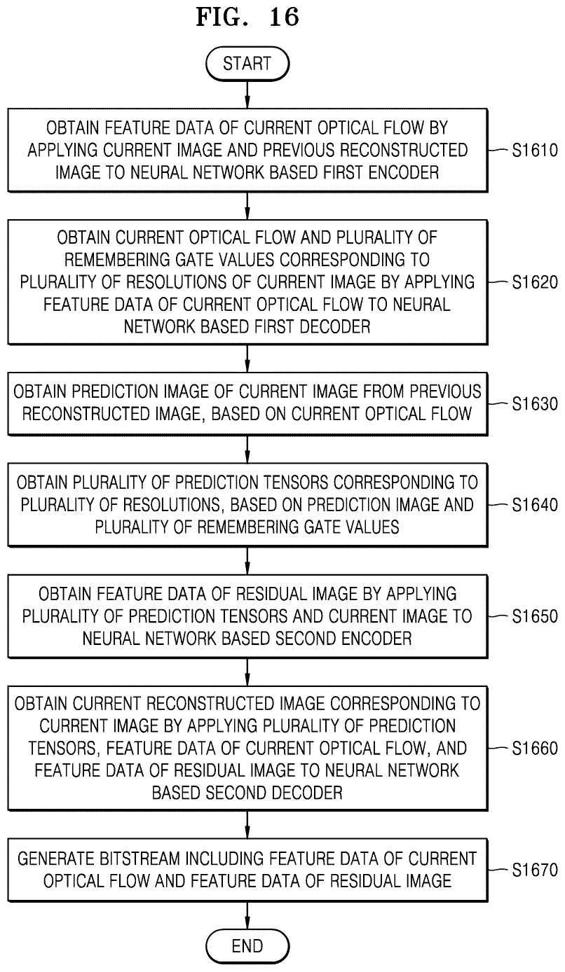

FIG. 16 is a flowchart of an image encoding method according to an embodiment of the present disclosure.

In operation S1610, an image encoding apparatus 1700 obtains feature data of a current optical flow by applying a current image and a previous reconstructed image to a neural network-based first encoder.

In operation S1620, the image encoding apparatus 1700 obtains a current optical flow and a plurality of remembering gate values corresponding to a plurality of resolutions of the current image by applying the feature data of the current optical flow to a neural network-based first decoder.

According to an embodiment of the present disclosure, the plurality of remembering gate values may represent values for maintaining information within the current image.

In operation S1630, the image encoding apparatus 1700 obtains a prediction image of the current image from the previous reconstructed image, based on the current optical flow.

In operation S1640, the image encoding apparatus 1700 obtains a plurality of prediction tensors corresponding to the plurality of resolutions, based on the prediction image and the plurality of remembering gate values.

According to an embodiment of the present disclosure, a plurality of forgetting gate values corresponding to the plurality of resolutions of the current image may be additionally obtained from the neural network-based first decoder, the plurality of prediction tensors may be obtained based on the prediction image, the plurality of remembering gate values, and the forgetting gate values, and the plurality of forgetting gate values may represent values for removing, from the current image, a region in which a prediction error is equal to or greater than a preset value.

According to an embodiment of the present disclosure, a prediction tensor of the original resolution of the current image from among the plurality of prediction tensors may be determined based on the prediction image and a remembering gate value corresponding to the original resolution.

According to an embodiment of the present disclosure, a prediction residual tensor may be obtained based on a subtraction tensor obtained by subtracting the prediction tensor of the original resolution of the current image from the prediction image and a forgetting gate value corresponding to the original resolution, and a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution.

According to an embodiment of the present disclosure, a prediction residual tensor may be obtained based on a remembering gate value corresponding to the original resolution of the current image, a forgetting gate value corresponding to the original resolution, and the prediction image, and a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution.

According to an embodiment of the present disclosure, a prediction residual tensor may be obtained by subtracting the prediction tensor of the original resolution of the current image from the prediction image, a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution, and a convolution kernel of a first layer of the downscale neural network may be linearly mixed with the forgetting gate value corresponding to the original resolution.

According to an embodiment of the present disclosure, a prediction residual tensor of a first downscaled resolution may be obtained based on a subtraction tensor, the subtraction tensor being obtained by subtracting a prediction tensor of the first downscaled resolution from an intermediate prediction tensor of the first downscaled resolution before applying a remembering gate value corresponding to the first downscaled resolution to a prediction tensor of the first downscaled resolution from among the plurality of prediction tensors, and a forgetting gate value corresponding to the first downscaled resolution, and a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution.

According to an embodiment of the present disclosure, a prediction residual tensor of a first downscaled resolution may be obtained based on a remembering gate value corresponding to the first downscaled resolution, a forgetting gate value corresponding to the first downscaled resolution, and an intermediate prediction tensor of the first downscaled resolution before applying the remembering gate value corresponding to the first downscaled resolution to the prediction tensor of the first downscaled resolution from among the plurality of prediction tensors, and a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution.

According to an embodiment of the present disclosure, a prediction residual tensor of a first downscaled resolution may be obtained by subtracting a prediction tensor of the first downscaled resolution from an intermediate prediction tensor of the first downscaled resolution before applying a remembering gate value corresponding to the first downscaled resolution to the prediction tensor of the first downscaled resolution from among the plurality of prediction tensors, a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution, and a convolution kernel of a first layer of the downscale neural network may be linearly mixed with a forgetting gate value corresponding to the first downscaled resolution.

In operation S1650, the image encoding apparatus 1700 obtains feature data of a residual image by applying the plurality of prediction tensors and the current image to a neural network-based second encoder.

In operation S1660, the image encoding apparatus 1700 obtains a current reconstructed image corresponding to the current image by applying the plurality of prediction tensors, the feature data of the current optical flow, and the feature data of the residual image to a neural network-based second decoder.

According to an embodiment of the present disclosure, the prediction residual tensor may be additionally applied to the neural network-based second encoder to obtain the feature data of the residual image, and the intermediate prediction tensor may be additionally applied to the neural network-based second decoder to obtain the current reconstructed image.

In operation S1670, the image encoding apparatus 1700 generates a bitstream including the feature data of the current optical flow and the feature data of the residual image.

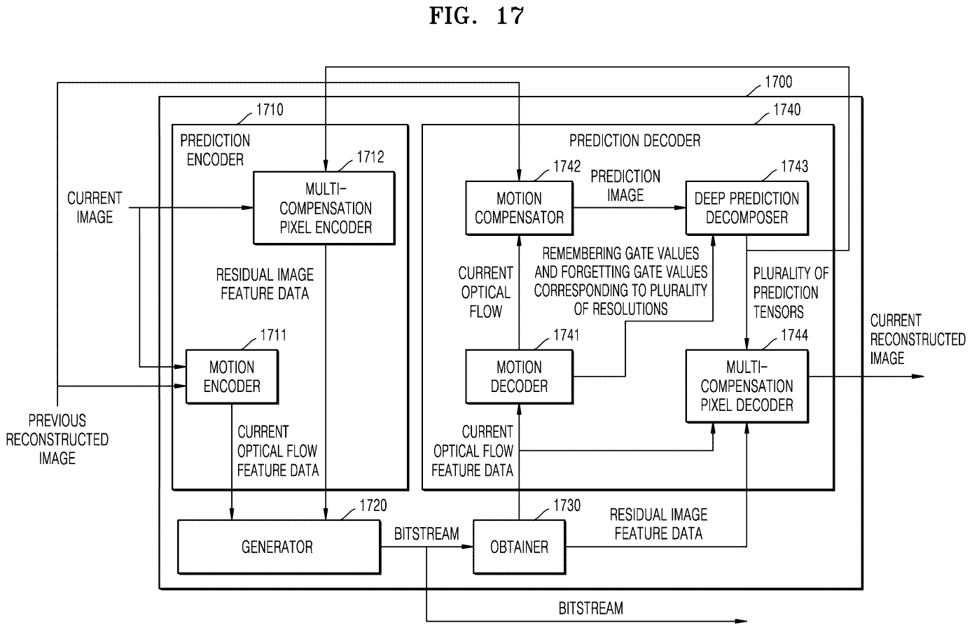

FIG. 17 is a block diagram of a structure of an image encoding apparatus according to an embodiment of the present disclosure.

Referring to FIG. 17, the image encoding apparatus 1700 may include a prediction encoder 1710, a generator 1720, an obtainer 1730, and a prediction decoder 1740.

The prediction encoder 1710, the generator 1720, the obtainer 1730, and the prediction decoder 1740 may be implemented as a processor. The processor may include at least one processing circuitry and/or a plurality of processors. For example, the term “processor” used herein, and also in the claims, may include various processing circuitry, including at least one processor. One or more processors in the at least one processor may be configured to individually and/or collectively perform the various functions described herein, in a distributed manner. As used herein, “a processor”, “at least one processor”, and “one or more processors” may be configured to perform several functions. However, these terms cover, but are not limited to, a situation where one processor performs some of the functions and other processor(s) perform others of the functions, and a situation where a single processor is capable of performing all of the functions. In addition, the at least one processor may include a combination of processors that perform various functions of the functions disclosed in a distributed manner. The at least one processor may execute program instructions in order to accomplish or perform various functions. The prediction encoder 1710, the generator 1720, the obtainer 1730, and the prediction decoder 1740 may operate according to instructions stored in a memory.

Although the prediction encoder 1710, the generator 1720, the obtainer 1730, and the prediction decoder 1740 are individually illustrated in FIG. 17, the prediction encoder 1710, the generator 1720, the obtainer 1730, and the prediction decoder 1740 may be implemented as one processor. In this case, the prediction encoder 1710, the generator 1720, the obtainer 1730, and the prediction decoder 1740 may be implemented as a dedicated processor, or may be implemented through a combination of software and a general-purpose processor such as an application processor (AP), a central processing unit (CPU), or a graphics processing unit (GPU). The dedicated processor may include a memory for implementing an embodiment of the disclosure or a memory processing unit for using an external memory.

The prediction encoder 1710, the generator 1720, the obtainer 1730, and the prediction decoder 1740 may be implemented as a plurality of processors. In this case, the prediction encoder 1710, the generator 1720, the obtainer 1730, and the prediction decoder 1740 may be implemented as a combination of dedicated processors, or may be implemented through a combination of software and a plurality of general-purpose processors such as APs, CPUs, or GPUs.

The prediction encoder 1710 may include a motion encoder 1711 and a multi-compensation pixel encoder 1712.

The motion encoder 1711 and the multi-compensation pixel encoder 1712 may be implemented as a neural network including one or more layers (e.g., one or more convolutional layers).

The motion encoder 1711 and the multi-compensation pixel encoder 1712 may be stored in a memory. The motion encoder 1711 and the multi-compensation pixel encoder 1712 may be implemented as at least one dedicated processor for AI.

The prediction encoder 1710 may obtain feature data of a current optical flow by using a current image and a previous reconstructed image, and may obtain residual image feature data by using the current image and a plurality of prediction tensors received from a deep prediction decomposer 1743 of the prediction decoder 1740. In detail, the motion encoder 1711 may receive the current image and the previous reconstructed image and thus output the feature data of the current optical flow. In addition, the multi-compensation pixel encoder 1712 may receive the plurality of prediction tensors from the deep prediction decomposer 1743 of the prediction decoder 1740 and the current image and may output the residual image feature data.

The feature data of the current optical flow and the residual image feature data both obtained by the prediction encoder 1710 may be transmitted to the generator 1720.

The generator 1720 may generate a bitstream including the feature data of the current optical flow and the residual image feature data.

According to an embodiment, the generator 1720 may generate a first bitstream corresponding to the feature data of the current optical flow and a second bitstream corresponding to the residual image feature data.

The bitstream may be transmitted from an image decoding apparatus 1900 through a network. According to an embodiment, the bitstream may be stored in a data storage medium including a magnetic medium (such as, a hard disk, a floppy disk, or a magnetic tape), an optical recording medium (such as, CD-ROM or DVD), or a magneto-optical medium (such as, a floptical disk).

The obtainer 1730 may obtain the feature data of the current optical flow and the residual image feature data from the bitstream generated by the generator 1720.

According to an embodiment, the obtainer 1730 may receive the feature data of the current optical flow and the residual image feature data from the prediction encoder 1710.

The feature data of the current optical flow and the residual image feature data may be transmitted to the prediction decoder 1740.

The prediction decoder 1740 may include a motion decoder 1741, a motion compensator 1742, the deep prediction decomposer 1743, and a multi-compensation pixel decoder 1744.

The motion decoder 1741, the deep prediction decomposer 1743, and the multi-compensation pixel decoder 1744 may be implemented as a neural network including one or more layers (e.g., one or more convolutional layers).

The motion decoder 1741, the deep prediction decomposer 1743, and the multi-compensation pixel decoder 1744 may be stored in a memory. The motion decoder 1741, the deep prediction decomposer 1743, and the multi-compensation pixel decoder 1744 may be implemented as at least one dedicated processor for AI.

The prediction decoder 1740 may obtain a current reconstructed image by using the feature data of the current optical flow and the residual image feature data. In detail, the motion decoder 1741 may receive the feature data of the current optical flow and output the current optical flow and remembering gate values and forgetting gate values corresponding to a plurality of resolutions. The current optical flow may be transmitted to the motion compensator 1742, and the remembering gate values and forgetting gate values corresponding to the plurality of resolutions may be transmitted to the deep prediction decomposer 1743. The motion compensator 1742 may obtain a prediction image by performing warping using the previous reconstructed image and the current optical flow. The prediction image may be transmitted to the deep prediction decomposer 1743. The deep prediction decomposer 1743 may obtain the plurality of prediction tensors by using the prediction image and the remembering gate values and forgetting gate values corresponding to the plurality of resolutions. The plurality of prediction tensors may be passed to the multi-compensation pixel encoder 1712 of the prediction encoder 1710 and the multi-compensation pixel decoder 1744 of the prediction decoder 1740. The multi-compensation pixel decoder 1744 may obtain the current reconstructed image by using the feature data of the current optical flow, the residual image feature data, and the plurality of prediction tensors.

Detailed operations of the motion encoder 1711, the multi-compensation pixel encoder 1712, the motion decoder 1741, the deep prediction decomposer 1743, and the multi-compensation pixel decoder 1744 are omitted as they have been described above with reference to FIGS. 3 through 14.

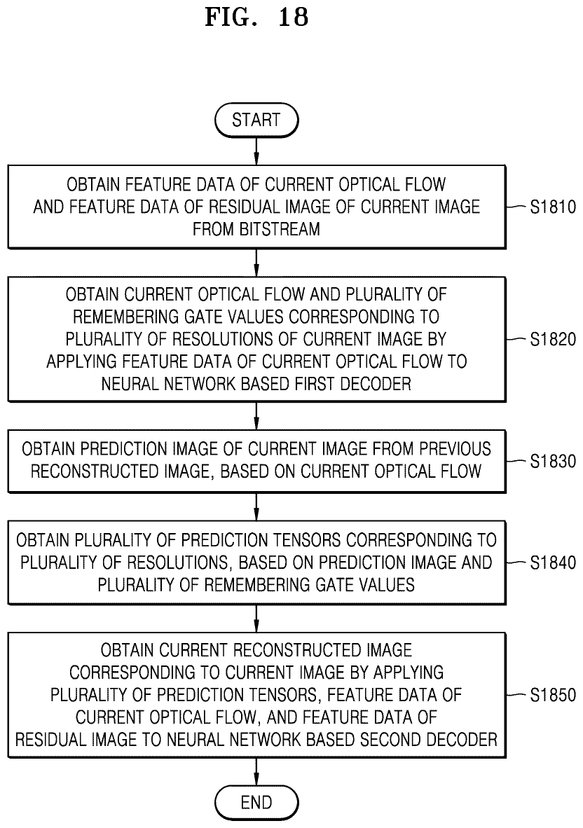

FIG. 18 is a flowchart of an image decoding method according to an embodiment of the present disclosure.

In operation S1810, the image decoding apparatus 1900 obtains feature data of a current optical flow and feature data of a residual image of a current image from a bitstream.

In operation S1820, the image decoding apparatus 1900 obtains a current optical flow and a plurality of remembering gate values corresponding to a plurality of resolutions of the current image by applying the feature data of the current optical flow to a neural network-based first decoder.

According to an embodiment of the present disclosure, the plurality of remembering gate values may represent values for maintaining information within the current image.

In operation S1830, the image decoding apparatus 1900 obtains a prediction image of the current image from a previous reconstructed image, based on the current optical flow.

In operation S1840, the image decoding apparatus 1900 obtains a plurality of prediction tensors corresponding to the plurality of resolutions, based on the prediction image and the plurality of remembering gate values.

According to an embodiment of the present disclosure, a plurality of forgetting gate values corresponding to the plurality of resolutions of the current image may be additionally obtained from the neural network-based first decoder, the plurality of prediction tensors may be obtained based on the prediction image, the plurality of remembering gate values, and the plurality of forgetting gate values, and the plurality of forgetting gate values may represent values for removing, from the current image, a region in which a prediction error is equal to or greater than a preset value.

According to an embodiment of the present disclosure, a prediction tensor of the original resolution of the current image from among the plurality of prediction tensors may be determined based on the prediction image and a remembering gate value corresponding to the original resolution.

According to an embodiment of the present disclosure, a prediction residual tensor may be obtained based on a subtraction tensor obtained by subtracting the prediction tensor of the original resolution of the current image from the prediction image and a forgetting gate value corresponding to the original resolution, and a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution.

According to an embodiment of the present disclosure, a prediction residual tensor may be obtained based on a remembering gate value corresponding to the original resolution of the current image, a forgetting gate value corresponding to the original resolution, and the prediction image, and a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution.

According to an embodiment of the present disclosure, a prediction residual tensor may be obtained by subtracting a second prediction tensor of the original resolution of the current image from the prediction image, a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution, and a convolution kernel of a first layer of the downscale neural network may be linearly mixed with the forgetting gate value corresponding to the original resolution.

According to an embodiment of the present disclosure, a prediction residual tensor of a first downscaled resolution may be obtained based on a subtraction tensor, the subtraction tensor being obtained by subtracting a prediction tensor of the first downscaled resolution from an intermediate prediction tensor of the first downscaled resolution before applying a remembering gate value corresponding to the first downscaled resolution to a prediction tensor of the first downscaled resolution from among the plurality of prediction tensors, and a forgetting gate value corresponding to the first downscaled resolution, and a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution.

According to an embodiment of the present disclosure, a prediction residual tensor of a first downscaled resolution may be obtained based on a remembering gate value corresponding to the first downscaled resolution, a forgetting gate value corresponding to the first downscaled resolution, and an intermediate prediction tensor of the first downscaled resolution before applying the remembering gate value corresponding to the first downscaled resolution to the prediction tensor of the first downscaled resolution from among the plurality of prediction tensors, and a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution.

According to an embodiment of the present disclosure, a prediction residual tensor of a first downscaled resolution may be obtained by subtracting a prediction tensor of the first downscaled resolution from an intermediate prediction tensor of the first downscaled resolution before applying a remembering gate value corresponding to the first downscaled resolution to the prediction tensor of the first downscaled resolution from among the plurality of prediction tensors, a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution, and a convolution kernel of a first layer of the downscale neural network may be linearly mixed with a forgetting gate value corresponding to the first downscaled resolution.

In operation S1850, the image decoding apparatus 1900 obtains a current reconstructed image corresponding to the current image by applying the plurality of prediction tensors, the feature data of the current optical flow, and the feature data of the residual image to a neural network-based second decoder.

According to an embodiment of the present disclosure, the intermediate prediction tensor may be additionally applied to the neural network-based second decoder to obtain the current reconstructed image.

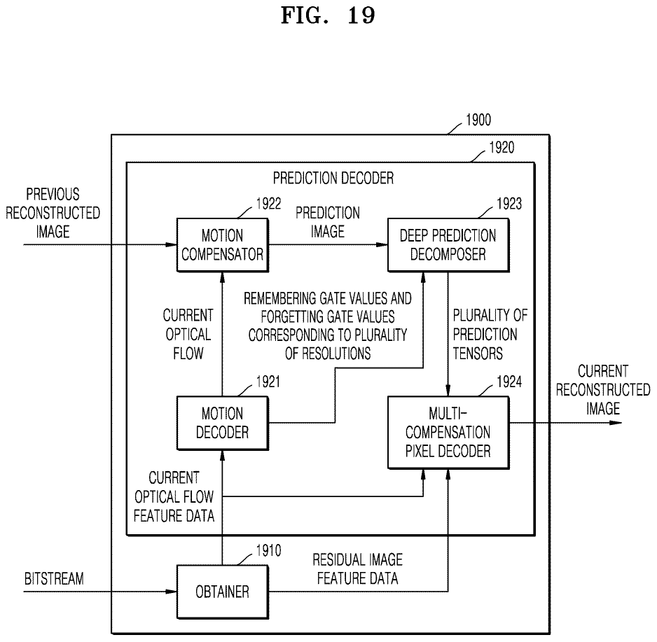

FIG. 19 is a block diagram of a structure of an image decoding apparatus according to an embodiment of the present disclosure.

Referring to FIG. 19, the image decoding apparatus 1900 may include an obtainer 1910 and a prediction decoder 1920.

The obtainer 1910 and the prediction decoder 1920 may be implemented as a processor. The processor may include at least one processing circuitry and/or a plurality of processors. For example, the term “processor” used herein, and also in the claims, may include various processing circuitry, including at least one processor. One or more processors in the at least one processor may be configured to individually and/or collectively perform the various functions described herein, in a distributed manner. As used herein, “a processor”, “at least one processor”, and “one or more processors” may be configured to perform several functions. However, these terms cover, but are not limited to, a situation where one processor performs some of the functions and other processor(s) perform others of the functions, and a situation where a single processor is capable of performing all of the functions. In addition, the at least one processor may include a combination of processors that perform various functions of the functions disclosed in a distributed manner. The at least one processor may execute program instructions in order to accomplish or perform various functions. The obtainer 1910 and the prediction decoder 1920 may operate according to instructions stored in a memory.

Although the obtainer 1910 and the prediction decoder 1920 are individually illustrated in FIG. 19, the obtainer 1910 and the prediction decoder 1920 may be implemented through one processor. In this case, the obtainer 1910 and the prediction decoder 1920 may be implemented as a dedicated processor, or may be implemented through a combination of software and a general-purpose processor such as an application processor (AP), a central processing unit (CPU), or a graphics processing unit (GPU). The dedicated processor may include a memory for implementing an embodiment of the disclosure or a memory processing unit for using an external memory.

The obtainer 1910 and the prediction decoder 1920 may be configured by a plurality of processors. In this case, the obtainer 1910 and the prediction decoder 1920 may be implemented as a combination of dedicated processors, or may be implemented through a combination of software and a plurality of general-purpose processors such as APs, CPUs, or GPUs.

The obtainer 1910 may obtain feature data of a current optical flow and residual image feature data from the bitstream.

The feature data of the current optical flow and the residual image feature data may be transmitted to the prediction decoder 1920.

The prediction decoder 1920 may include a motion decoder 1921, a motion compensator 1922, a deep prediction decomposer 1923, and a multi-compensation pixel decoder 1924.

The motion decoder 1921, the deep prediction decomposer 1923, and the multi-compensation pixel decoder 1924 may be implemented as a neural network including one or more layers (e.g., one or more convolutional layers).

The motion decoder 1921, the deep prediction decomposer 1923, and the multi-compensation pixel decoder 1924 may be stored in a memory. The motion decoder 1921, the deep prediction decomposer 1923, and the multi-compensation pixel decoder 1924 may be implemented as at least one dedicated processor for AI.

The prediction decoder 1920 may obtain a current reconstructed image by using the feature data of the current optical flow and the residual image feature data. In detail, the motion decoder 1921 may receive the feature data of the current optical flow and output the current optical flow and remembering gate values and forgetting gate values corresponding to a plurality of resolutions. The current optical flow may be transmitted to the motion compensator 1922, and the remembering gate values and forgetting gate values corresponding to the plurality of resolutions may be transmitted to the deep prediction decomposer 1743. The motion compensator 1922 may obtain a prediction image by performing warping using the previous reconstructed image and the current optical flow. The prediction image may be transmitted to the deep prediction decomposer 1923. The deep prediction decomposer 1923 may obtain a plurality of prediction tensors by using the prediction image and the remembering gate values and forgetting gate values corresponding to the plurality of resolutions. The multi-compensation pixel decoder 1924 may obtain the current reconstructed image by using the feature data of the current optical flow, the residual image feature data, and the plurality of prediction tensors.

Detailed operations of the motion decoder 1921, the deep prediction decomposer 1923, and the multi-compensation pixel decoder 1924 are omitted as they have been described above with reference to FIGS. 3 through 14.

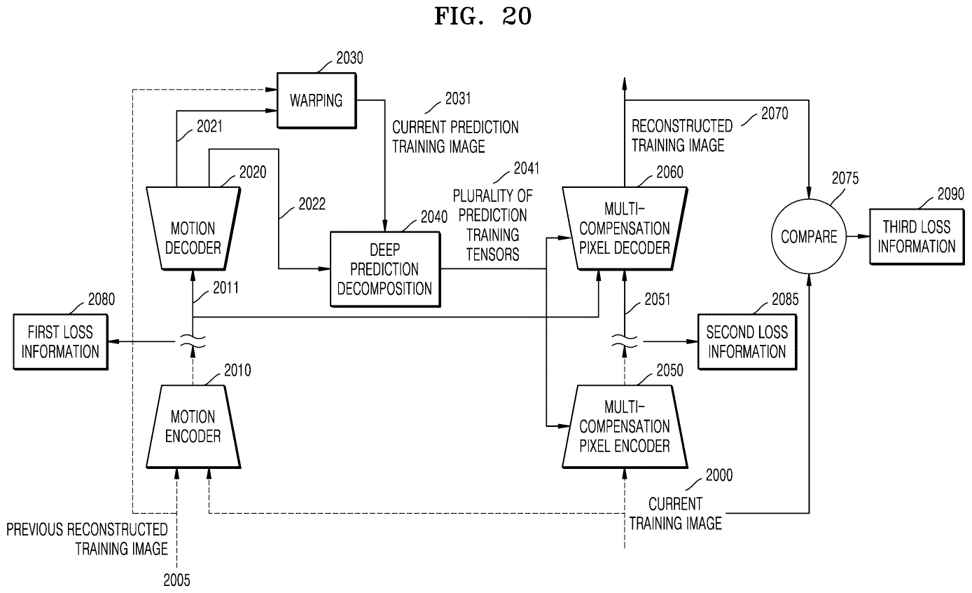

FIG. 20 is a diagram for explaining a method of training neural networks of a motion encoder, a motion decoder, a deep prediction decomposition, a multi-compensation pixel encoder, and a multi-compensation pixel decoder.

In FIG. 20, a current training image 2000, a previous reconstructed training image 2005, and a reconstructed training image 2070 correspond to the aforementioned current image, the aforementioned previous reconstructed image, and the aforementioned reconstructed image, respectively.

When neural networks of a motion encoder 2010, a motion decoder 2020, deep prediction decomposition 2040, a multi-compensation pixel encoder 2050, and a multi-compensation pixel decoder 2060 are trained, a similarity between the reconstructed training image 2070 and the current training image 2000 and a bit rate of a bitstream to be generated by encoding the current training image 2000 need to be considered.

To this end, according to an embodiment, the neural networks of the motion encoder 2010, the motion decoder 2020, the deep prediction decomposition 2040, the multi-compensation pixel encoder 2050, and the multi-compensation pixel decoder 2060 may be trained according to first loss information 20800 and second loss information 2085 corresponding to a size of the bitstream and third loss information 2090 corresponding to the similarity between the current training image 2000 and the reconstructed training image 2070.

Referring to FIG. 20, the current training image 2000 and the previous reconstructed training image 2005 may be input to the motion encoder 2010. The optical flow encoder 2010 may output feature data 2011 of the current optical flow by processing the current training image 2000 and the previous reconstructed training image 2005.

The feature data 2011 of the current optical flow may be input to the optical flow decoder 2020, and the motion decoder 2020 may output a current optical flow 2021 and remembering gate values and forgetting gate values 2022 corresponding to a plurality of resolutions by processing the feature data 2011 of the current optical flow.

The previous reconstructed training image 2005 may be warped via warping 2030 according to the current optical flow 2021 to generate a current prediction training image 2031.

The current prediction training image 2031 and the remembering gate values and forgetting gate values 2022 corresponding to the plurality of resolutions may be used during the deep prediction decomposition 2040. Through the deep prediction decomposition 2040, a plurality of prediction training tensors 2041 corresponding to the plurality of resolutions may be output.

The current training image 2420 and the plurality of prediction training tensors 2041 may be input to the multi-compensation pixel encoder 2050, and residual image feature data 2051 may be output by the multi-compensation pixel encoder 2050.

The feature data 2011 of the current optical flow, the residual image feature data 2051, and the plurality of prediction training tensors 2041 may be input to the multi-compensation pixel decoder 2060, and the reconstructed training image 2070 may be output by the multi-compensation pixel decoder 2060.

In order to train the neural networks of the motion encoder 2010, the motion decoder 2020, the deep prediction decomposition 2040, the multi-compensation pixel encoder 2050, and the multi-compensation pixel decoder 2060, at least one of the first loss information 2080, the second loss information 2085, or the third loss information 2090 may be obtained.

The first loss information 2080 may be calculated from entropy of the feature data 2011 of the current optical flow or a bit rate of a bitstream corresponding to the feature data 2011 of the current optical flow.

The second loss information 2085 may be calculated from entropy of the residual image feature data 2051 or a bit rate of a bitstream corresponding to the residual image feature data 2051.

Because the first loss information 2080 and the second loss information 2085 are related to the efficiency of encoding the current training image 2000, the first loss information 2080 and the second loss information 2085 may be referred to as compression loss information.

According to an embodiment, although the first loss information 2080 and the second loss information 2085 related to the bitrate of a bitstream are derived in FIG. 20, one piece of loss information corresponding to the bitrate of one bitstream generated through encoding of the current training image 2000 may be derived.

The third loss information 2090 may correspond to a difference between the current training image 2000 and the reconstructed training image 2070. That is, the third loss information 2090 may be obtained through a comparison 2075 between the current training image 2000 and the reconstructed training image 2070. The difference between the current training image 2000 and the reconstructed training image 2070 may include at least one of a L1-norm value, an L2-norm value, a Structural Similarity (SSIM) value, a Peak Signal-To-Noise Ratio-Human Vision System (PSNR-HVS) value, a Multiscale SSIM (MS-SSIM) value, a Variance Inflation Factor (VIF) value, or a Video Multimethod Assessment Fusion (VMAF) value between the current training image 2000 and the reconstructed training image 2070.

Because the third loss information 2090 is related to the quality of the reconstructed training image 2070, the third loss information 2090 may be referred to as quality loss information.

The neural networks of the motion encoder 2010, the motion decoder 2020, the deep prediction decomposition 2040, the multi-compensation pixel encoder 2050, and the multi-compensation pixel decoder 2060 may be trained so that final loss information derived from at least one of the first loss information 2080, the second loss information 2085, and the third loss information 2090 may be reduced or minimized.

In detail, the neural networks of the motion encoder 2010, the motion decoder 2020, the deep prediction decomposition 2040, the multi-compensation pixel encoder 2050, and the multi-compensation pixel decoder 2060 may be trained so that final loss information may be reduced or minimized while values of pre-set parameters are being changed.

According to an embodiment of the disclosure, the final loss information may be calculated according to Equation 1 below.

Final loss information=a*first loss information+b*second loss information+c*third loss information [Equation 1]

In Equation 1, a, b, and c denote weights that are applied to the first loss information 2080, the second loss information 2085, and the third loss information 2090, respectively.

According to Equation 1, it is found that the neural networks of the motion encoder 2010, the motion decoder 2020, the deep prediction decomposition 2040, the multi-compensation pixel encoder 2050, and the multi-compensation pixel decoder 2060 may be trained so that the reconstructed training image 2070 is as similar as possible to the current training image 2000 and a size of a bitstream corresponding to data output by the motion encoder 2010 and the multi-compensation pixel encoder 2050 is minimized.

An image decoding method according to an embodiment may include obtaining feature data of a current optical flow and feature data of a residual image of a current image from a bitstream; obtaining the current optical flow and a plurality of remembering gate values corresponding to a plurality of resolutions of the current image by applying the feature data of the current optical flow to a neural network based first decoder; obtaining a prediction image of the current image from a previous reconstructed image, based on the current optical flow; obtaining a plurality of prediction tensors corresponding to the plurality of resolutions, based on the prediction image and the plurality of remembering gate values; and obtaining a current reconstructed image corresponding to the current image by applying the plurality of prediction tensors, the feature data of the current optical flow, and the feature data of the residual image to a neural network-based second decoder.

According to an embodiment of the present disclosure, the plurality of remembering gate values may represent values for maintaining information within the current image.

In the image decoding method according to an embodiment of the present disclosure, an image may be reconstructed based on a plurality of prediction tensors corresponding to a plurality of resolutions obtained using a plurality of remembering gate values representing values for maintaining major information in the image, so that the major information of the image may be maintained. Thus, occurrence of errors in the reconstructed image may be prevented, and the accuracy and coding efficiency of the image may be improved.

According to an embodiment of the present disclosure, a plurality of forgetting gate values corresponding to the plurality of resolutions of the current image may be additionally obtained from the neural network-based first decoder, the plurality of prediction tensors may be obtained based on a first prediction image, the plurality of remembering gate values, and the plurality of forgetting gate values, and the plurality of forgetting gate values may represent values for removing, from the current image, a region in which a prediction error is equal to or greater than a preset value.

In the image decoding method according to an embodiment of the present disclosure, a plurality of prediction tensors may be obtained by additionally using a value for removing, from an image, a region in which a prediction error is equal to or greater than a preset value, that is, a poorly-predicted region, and an image may be reconstructed based on the plurality of prediction tensors corresponding to a plurality of resolutions, so that unnecessary information of the image may be removed. Thus, occurrence of errors in the reconstructed image may be prevented, and the accuracy and coding efficiency of the image may be improved.

According to an embodiment of the present disclosure, a prediction tensor of the original resolution of the current image from among the plurality of prediction tensors may be determined based on the prediction image and a remembering gate value corresponding to the original resolution.

According to an embodiment of the present disclosure, a prediction residual tensor may be obtained based on a subtraction tensor obtained by subtracting the prediction tensor of the original resolution of the current image from the prediction image and a forgetting gate value corresponding to the original resolution, and a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution.

According to an embodiment of the present disclosure, a prediction residual tensor may be obtained based on a remembering gate value corresponding to the original resolution of the current image, a forgetting gate value corresponding to the original resolution, and the prediction image, and a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution.

According to an embodiment of the present disclosure, a prediction residual tensor may be obtained by subtracting the prediction tensor of the original resolution of the current image from the prediction image, a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution, and a convolution kernel of a first layer of the downscale neural network may be linearly mixed with the forgetting gate value corresponding to the original resolution.

According to an embodiment of the present disclosure, a prediction residual tensor of a first downscaled resolution may be obtained based on a subtraction tensor, the subtraction tensor being obtained by subtracting a prediction tensor of the first downscaled resolution from an intermediate prediction tensor of the first downscaled resolution before applying a remembering gate value corresponding to the first downscaled resolution to a prediction tensor of the first downscaled resolution from among the plurality of prediction tensors, and a forgetting gate value corresponding to the first downscaled resolution, and a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution.

According to an embodiment of the present disclosure, a prediction residual tensor of a first downscaled resolution may be obtained based on a remembering gate value corresponding to the first downscaled resolution, a forgetting gate value corresponding to the first downscaled resolution, and an intermediate prediction tensor of the first downscaled resolution before applying the remembering gate value corresponding to the first downscaled resolution to the prediction tensor of the first downscaled resolution from among the plurality of prediction tensors, and a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution.

According to an embodiment of the present disclosure, a prediction residual tensor of a first downscaled resolution may be obtained by subtracting a prediction tensor of the first downscaled resolution from an intermediate prediction tensor of the first downscaled resolution before applying a remembering gate value corresponding to the first downscaled resolution to the prediction tensor of the first downscaled resolution from among the plurality of prediction tensors, a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution, and a convolution kernel of a first layer of the downscale neural network may be linearly mixed with a forgetting gate value corresponding to the first downscaled resolution.

In the image decoding method according to an embodiment of the present disclosure, a prediction image of a current image may be decomposed into prediction tensors of a plurality of resolutions by using remembering gate values and forgetting gate values corresponding to the plurality of resolutions, and an image may be reconstructed based on a plurality of prediction tensors corresponding to a plurality of resolutions, so that major information of the image may be maintained and unnecessary information may be removed. Thus, occurrence of errors may be prevented, and the accuracy and coding efficiency of the image may be improved.

According to an embodiment of the present disclosure, the intermediate prediction tensor may be additionally applied to the neural network-based second decoder to obtain the current reconstructed image.

In the image decoding method according to an embodiment of the present disclosure, additional information may be used in residual coding, so that the accuracy and coding efficiency of an image may be improved.

An image decoding apparatus according to an embodiment may include memory storing one or more instructions; and at least one processor operating according to the one or more instructions. The at least one processor may be configured to obtain feature data of a current optical flow and feature data of a residual image of a current image from a bitstream, obtain the current optical flow and a plurality of remembering gate values corresponding to a plurality of resolutions of the current image by applying the feature data of the current optical flow to a neural network-based first decoder, obtain a prediction image of the current image from a previous reconstructed image, based on the current optical flow, obtain a plurality of prediction tensors corresponding to the plurality of resolutions, based on the prediction image and the plurality of remembering gate values, and obtain a current reconstructed image corresponding to the current image by applying the plurality of prediction tensors, the feature data of the current optical flow, and the feature data of the residual image to a neural network-based second decoder.

According to an embodiment of the present disclosure, the plurality of remembering gate values may represent values for maintaining information within the current image.

In the image decoding apparatus according to an embodiment of the present disclosure, an image may be reconstructed based on a plurality of prediction tensors corresponding to a plurality of resolutions obtained using a plurality of remembering gate values representing values for maintaining major information in the image, so that the major information of the image may be maintained. Thus, occurrence of errors in the reconstructed image may be prevented, and the accuracy and coding efficiency of the image may be improved.

According to an embodiment of the present disclosure, a plurality of forgetting gate values corresponding to the plurality of resolutions of the current image may be additionally obtained from the first decoder based on a neural network, the plurality of prediction tensors may be obtained based on the prediction image, the plurality of remembering gate values, and the plurality of forgetting gate values, and the plurality of forgetting gate values may represent values for removing, from the current image, a region in which a prediction error is equal to or greater than a preset value.

In the image decoding apparatus according to an embodiment of the present disclosure, a plurality of prediction tensors may be obtained by additionally using a value for removing, from an image, a region in which a prediction error is equal to or greater than a preset value, and an image may be reconstructed based on the plurality of prediction tensors corresponding to a plurality of resolutions, so that unnecessary information of the image may be removed. Thus, occurrence of errors in the reconstructed image may be prevented, and the accuracy and coding efficiency of the image may be improved.

According to an embodiment of the present disclosure, a prediction tensor of the original resolution of the current image from among the plurality of prediction tensors may be determined based on the prediction image and a remembering gate value corresponding to the original resolution.

According to an embodiment of the present disclosure, a prediction residual tensor may be obtained based on a subtraction tensor obtained by subtracting the prediction tensor of the original resolution of the current image from the prediction image and a forgetting gate value corresponding to the original resolution, and a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution.

According to an embodiment of the present disclosure, a prediction residual tensor may be obtained based on a remembering gate value corresponding to the original resolution of the current image, a forgetting gate value corresponding to the original resolution, and the prediction image, and a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution.

According to an embodiment of the present disclosure, a prediction residual tensor may be obtained by subtracting the prediction tensor of the original resolution of the current image from the prediction image, a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution, and a convolution kernel of a first layer of the downscale neural network may be linearly mixed with the forgetting gate value corresponding to the original resolution.

According to an embodiment of the present disclosure, a prediction residual tensor of a first downscaled resolution may be obtained based on a subtraction tensor, the subtraction tensor being obtained by subtracting a prediction tensor of the first downscaled resolution from an intermediate prediction tensor of the first downscaled resolution before applying a remembering gate value corresponding to the first downscaled resolution to a prediction tensor of the first downscaled resolution from among the plurality of prediction tensors, and a forgetting gate value corresponding to the first downscaled resolution, and a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution.

According to an embodiment of the present disclosure, a prediction residual tensor of a first downscaled resolution may be obtained based on a remembering gate value corresponding to the first downscaled resolution, a forgetting gate value corresponding to the first downscaled resolution, and an intermediate prediction tensor of the first downscaled resolution before applying the remembering gate value corresponding to the first downscaled resolution to the prediction tensor of the first downscaled resolution from among the plurality of prediction tensors, and a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution.

According to an embodiment of the present disclosure, a prediction residual tensor of a first downscaled resolution may be obtained by subtracting a prediction tensor of the first downscaled resolution from an intermediate prediction tensor of the first downscaled resolution before applying a remembering gate value corresponding to the first downscaled resolution to the prediction tensor of the first downscaled resolution from among the plurality of prediction tensors, a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution, and a convolution kernel of a first layer of the downscale neural network may be linearly mixed with a forgetting gate value corresponding to the first downscaled resolution.

In the image decoding apparatus according to an embodiment of the present disclosure, a prediction image of a current image may be decomposed into prediction tensors of a plurality of resolutions by using remembering gate values and forgetting gate values corresponding to the plurality of resolutions, and an image may be reconstructed based on a plurality of prediction tensors corresponding to a plurality of resolutions, so that major information of the image may be maintained and unnecessary information may be removed. Thus, occurrence of errors may be prevented, and the accuracy and coding efficiency of the image may be improved.

According to an embodiment of the present disclosure, the intermediate prediction tensor may be additionally applied to the neural network-based second decoder to obtain the current reconstructed image.

In the image decoding apparatus according to an embodiment of the present disclosure, additional information may be used in residual coding, so that the accuracy and coding efficiency of an image may be improved.

An image encoding method according to an embodiment may include obtaining feature data of a current optical flow by applying a current image and a previous reconstructed image to a neural network-based first encoder; obtaining the current optical flow and a plurality of remembering gate values corresponding to a plurality of resolutions of the current image by applying the feature data of the current optical flow to a neural network-based first; obtaining a prediction image of the current image from the previous reconstructed image, based on the current optical flow; obtaining a plurality of prediction tensors corresponding to the plurality of resolutions, based on the prediction image and the plurality of remembering gate values; obtaining feature data of a residual image by applying the plurality of prediction tensors and the current image to a neural network-based second encoder; obtaining a current reconstructed image corresponding to the current image by applying the plurality of prediction tensors, the feature data of the current optical flow, and the feature data of the residual image to a neural network-based second decoder; and generating a bitstream including the feature data of the current optical flow and the feature data of the residual image.

According to an embodiment of the present disclosure, the plurality of remembering gate values may represent values for maintaining information within the current image.

In the image encoding method according to an embodiment of the present disclosure, an image may be reconstructed based on a plurality of prediction tensors corresponding to a plurality of resolutions obtained using a plurality of remembering gate values representing values for maintaining major information in the image, so that the major information of the image may be maintained. Thus, occurrence of errors in the reconstructed image may be prevented, and the accuracy and coding efficiency of the image may be improved.

According to an embodiment of the present disclosure, a plurality of forgetting gate values corresponding to the plurality of resolutions of the current image may be additionally obtained from the neural network-based first decoder, the plurality of prediction tensors may be obtained based on the prediction image, the plurality of remembering gate values, and the plurality of forgetting gate values, and the plurality of forgetting gate values may represent values for removing, from the current image, a region in which a prediction error is equal to or greater than a preset value.

In the image encoding method according to an embodiment of the present disclosure, a plurality of prediction tensors may be obtained by additionally using a value for removing, from an image, a region in which a prediction error is equal to or greater than a preset value, and an image may be reconstructed based on the plurality of prediction tensors corresponding to a plurality of resolutions, so that unnecessary information of the image may be removed. Thus, occurrence of errors in the reconstructed image may be prevented, and the accuracy and coding efficiency of the image may be improved.

According to an embodiment of the present disclosure, a prediction tensor of the original resolution of the current image from among the plurality of prediction tensors may be determined based on the prediction image and a remembering gate value corresponding to the original resolution.

According to an embodiment of the present disclosure, a prediction residual tensor may be obtained based on a subtraction tensor obtained by subtracting the prediction tensor of the original resolution of the current image from the prediction image and a forgetting gate value corresponding to the original resolution, and a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution.

According to an embodiment of the present disclosure, a prediction residual tensor may be obtained based on a remembering gate value corresponding to the original resolution of the current image, a forgetting gate value corresponding to the original resolution, and the prediction image, and a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution.

According to an embodiment of the present disclosure, a prediction residual tensor may be obtained by subtracting the prediction tensor of the original resolution of the current image from the prediction image, a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution, and a convolution kernel of a first layer of the downscale neural network may be linearly mixed with the forgetting gate value corresponding to the original resolution.

According to an embodiment of the present disclosure, a prediction residual tensor of a first downscaled resolution may be obtained based on a subtraction tensor, the subtraction tensor being obtained by subtracting a prediction tensor of the first downscaled resolution from an intermediate prediction tensor of the first downscaled resolution before applying a remembering gate value corresponding to the first downscaled resolution to a prediction tensor of the first downscaled resolution from among the plurality of prediction tensors, and a forgetting gate value corresponding to the first downscaled resolution, and a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution.

According to an embodiment of the present disclosure, a prediction residual tensor of a first downscaled resolution may be obtained based on a remembering gate value corresponding to the first downscaled resolution, a forgetting gate value corresponding to the first downscaled resolution, and an intermediate prediction tensor of the first downscaled resolution before applying the remembering gate value corresponding to the first downscaled resolution to the prediction tensor of the first downscaled resolution from among the plurality of prediction tensors, and a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution.

According to an embodiment of the present disclosure, a prediction residual tensor of a first downscaled resolution may be obtained by subtracting a prediction tensor of the first downscaled resolution from an intermediate prediction tensor of the first downscaled resolution before applying a remembering gate value corresponding to the first downscaled resolution to the prediction tensor of the first downscaled resolution from among the plurality of prediction tensors, a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution, and a convolution kernel of a first layer of the downscale neural network may be linearly mixed with a forgetting gate value corresponding to the first downscaled resolution.

In the image encoding method according to an embodiment of the present disclosure, a prediction image of a current image may be decomposed into prediction tensors of a plurality of resolutions by using remembering gate values and forgetting gate values corresponding to the plurality of resolutions, and an image may be reconstructed based on a plurality of prediction tensors corresponding to the plurality of resolutions, so that major information of the image may be maintained and unnecessary information may be removed. Thus, occurrence of errors may be prevented, and the accuracy and coding efficiency of the image may be improved.

According to an embodiment of the present disclosure, the prediction residual tensor may be additionally applied to the neural network-based second encoder to obtain the feature data of the residual image, and the intermediate prediction tensor may be additionally applied to the neural network-based second decoder to obtain the current reconstructed image.

In the image encoding method according to an embodiment of the present disclosure, additional information may be used in residual coding, so that the accuracy and coding efficiency of an image may be improved.

An image encoding apparatus according to an embodiment may include memory storing one or more instructions; and at least one processor operating according to the one or more instructions. The at least one processor may be configured to obtain feature data of a current optical flow by applying a current image and a previous reconstructed image to a neural network-based first encoder, obtain the current optical flow and a plurality of remembering gate values corresponding to a plurality of resolutions of the current image by applying the feature data of the current optical flow to a neural network-based first decoder, obtain a prediction image of the current image from the previous reconstructed image, based on the current optical flow, obtain a plurality of prediction tensors corresponding to the plurality of resolutions, based on the prediction image and the plurality of remembering gate values, obtain feature data of a residual image by applying the plurality of second prediction tensors and the current image to a neural network-based second encoder; obtain a current reconstructed image corresponding to the current image by applying the plurality of second prediction tensors, the feature data of the current optical flow, and the feature data of the residual image to a neural network-based second decoder; and generating a bitstream including the feature data of the current optical flow and the feature data of the residual image.

According to an embodiment of the present disclosure, the plurality of remembering gate values may represent values for maintaining information within the current image.

In the image encoding apparatus according to an embodiment of the present disclosure, an image may be reconstructed based on a plurality of prediction tensors corresponding to a plurality of resolutions obtained using a plurality of remembering gate values representing values for maintaining major information in the image, so that the major information of the image may be maintained. Thus, occurrence of errors in the reconstructed image may be prevented, and the accuracy and coding efficiency of the image may be improved.

According to an embodiment of the present disclosure, a plurality of forgetting gate values corresponding to the plurality of resolutions of the current image may be additionally obtained from the neural network-based first decoder, the plurality of prediction tensors may be obtained based on a first prediction image, the plurality of remembering gate values, and the plurality of forgetting gate values, and the plurality of forgetting gate values may represent values for removing, from the current image, a region in which a prediction error is equal to or greater than a preset value.

In the image encoding apparatus according to an embodiment of the present disclosure, a plurality of prediction tensors may be obtained by additionally using a value for removing, from an image, a region in which a prediction error is equal to or greater than a preset value, and an image may be reconstructed based on the plurality of prediction tensors corresponding to a plurality of resolutions, so that unnecessary information of the image may be removed. Thus, occurrence of errors in the reconstructed image may be prevented, and the accuracy and coding efficiency of the image may be improved.

According to an embodiment of the present disclosure, a prediction tensor of the original resolution of the current image from among the plurality of prediction tensors may be determined based on the prediction image and a remembering gate value corresponding to the original resolution.

According to an embodiment of the present disclosure, a prediction residual tensor may be obtained based on a subtraction tensor obtained by subtracting the prediction tensor of the original resolution of the current image from the prediction image and a forgetting gate value corresponding to the original resolution, and a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution.

According to an embodiment of the present disclosure, a prediction residual tensor may be obtained based on a remembering gate value corresponding to the original resolution of the current image, a forgetting gate value corresponding to the original resolution, and the prediction image, and a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution.

According to an embodiment of the present disclosure, a prediction residual tensor may be obtained by subtracting the prediction tensor of the original resolution of the current image from the prediction image, a prediction tensor of a resolution downscaled from the original resolution may be determined from among the plurality of prediction tensors, based on an intermediate prediction tensor of the downscaled resolution, the intermediate prediction tensor being obtained by applying the prediction residual tensor to a downscale neural network, and a remembering gate value corresponding to the downscaled resolution, and a convolution kernel of a first layer of the downscale neural network may be linearly mixed with the forgetting gate value corresponding to the original resolution.

According to an embodiment of the present disclosure, a prediction residual tensor of a first downscaled resolution may be obtained based on a subtraction tensor, the subtraction tensor being obtained by subtracting a prediction tensor of the first downscaled resolution from an intermediate prediction tensor of the first downscaled resolution before applying a remembering gate value corresponding to the first downscaled resolution to a prediction tensor of the first downscaled resolution from among the plurality of prediction tensors, and a forgetting gate value corresponding to the first downscaled resolution, and a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution.

According to an embodiment of the present disclosure, a prediction residual tensor of a first downscaled resolution may be obtained based on a remembering gate value corresponding to the first downscaled resolution, a forgetting gate value corresponding to the first downscaled resolution, and an intermediate prediction tensor of the first downscaled resolution before applying the remembering gate value corresponding to the first downscaled resolution to the prediction tensor of the first downscaled resolution from among the plurality of prediction tensors, and a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution.

According to an embodiment of the present disclosure, a prediction residual tensor of a first downscaled resolution may be obtained by subtracting a prediction tensor of the first downscaled resolution from an intermediate prediction tensor of the first downscaled resolution before applying a remembering gate value corresponding to the first downscaled resolution to the prediction tensor of the first downscaled resolution from among the plurality of prediction tensors, a prediction tensor of a second downscaled resolution obtained by downscaling the first downscaled resolution may be determined from among the plurality of prediction tensors, based on an intermediate prediction tensor of the second downscaled resolution, the intermediate prediction tensor being obtained by applying the prediction residual tensor to a downscale neural network, and a remembering gate value corresponding to the second downscaled resolution, and a convolution kernel of a first layer of the downscale neural network may be linearly mixed with a forgetting gate value corresponding to the first downscaled resolution.

In the image encoding apparatus according to an embodiment of the present disclosure, a prediction image of a current image may be decomposed into prediction tensors of a plurality of resolutions by using remembering gate values and forgetting gate values corresponding to the plurality of resolutions, and an image may be reconstructed based on a plurality of prediction tensors corresponding to a plurality of resolutions, so that major information of the image may be maintained and unnecessary information may be removed. Thus, occurrence of errors may be prevented, and the accuracy and coding efficiency of the image may be improved.

According to an embodiment of the present disclosure, the prediction residual tensor may be additionally applied to the neural network-based second encoder to obtain the feature data of the residual image, and the intermediate prediction tensor may be additionally applied to the neural network-based second decoder to obtain the current reconstructed image.

In the image encoding method according to an embodiment of the present disclosure, additional information may be used in residual coding, so that the accuracy and coding efficiency of an image may be improved.

The machine-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored. For example, the ‘non-transitory recording medium’ may include a buffer in which data is temporarily stored.

According to an embodiment, methods according to various disclosed embodiments may be provided by being included in a computer program product. The computer program product, which is a commodity, may be traded between sellers and buyers. Computer program products are distributed in the form of device-readable storage media (e.g., compact disc read only memory (CD-ROM)), or may be distributed (e.g., downloaded or uploaded) through an application store or between two user devices (e.g., smartphones) directly and online. In the case of online distribution, at least a portion of the computer program product (e.g., a downloadable app) may be stored at least temporarily in a device-readable storage medium, such as a memory of a manufacturer's server, a server of an application store, or a relay server, or may be temporarily generated.

What is claimed is:

1. An image decoding method comprising:
obtaining, from a bitstream, feature data of a current optical flow and feature data of a residual image of a current image;
obtaining, by applying the feature data of the current optical flow to a neural network-based first decoder, the current optical flow and a plurality of remembering gate values corresponding to a plurality of resolutions of the current image;
obtaining a prediction image of the current image from a previous reconstructed image, based on the current optical flow;
obtaining a plurality of prediction tensors corresponding to the plurality of resolutions, based on the prediction image and the plurality of remembering gate values; and
obtaining a current reconstructed image corresponding to the current image by applying the plurality of prediction tensors, the feature data of the current optical flow, and the feature data of the residual image to a neural network-based second decoder.

2. The image decoding method of claim 1, wherein
the plurality of remembering gate values represent values for maintaining information within the current image.

3. The image decoding method of claim 1, wherein
a plurality of forgetting gate values corresponding to the plurality of resolutions of the current image are additionally obtained from the neural network-based first decoder,
the plurality of prediction tensors are obtained based on the prediction image, the plurality of remembering gate values, and the plurality of forgetting gate values, and
the plurality of forgetting gate values represent values for removing, from the current image, a region in which a prediction error is equal to or greater than a preset value.

4. The image decoding method of claim 1, wherein
a prediction tensor of an original resolution of the current image from among the plurality of prediction tensors is determined based on the prediction image and a remembering gate value corresponding to the original resolution.

5. The image decoding method of claim 4, wherein
a prediction residual tensor is obtained based on a subtraction tensor and a forgetting gate value corresponding to the original resolution, the subtraction tensor is obtained by subtracting the prediction tensor of the original resolution of the current image from the prediction image, and
a prediction tensor of a resolution downscaled from the original resolution is determined from among the plurality of prediction tensors, based on an intermediate prediction tensor of the downscaled resolution and a remembering gate value corresponding to the downscaled resolution, the intermediate prediction tensor being obtained by applying the prediction residual tensor to a downscale neural network.

6. The image decoding method of claim 4, wherein
a prediction residual tensor is obtained based on a remembering gate value corresponding to the original resolution of the current image, a forgetting gate value corresponding to the original resolution, and the prediction image, and
a prediction tensor of a resolution downscaled from the original resolution is determined from among the plurality of prediction tensors, based on an intermediate prediction tensor of the downscaled resolution and a remembering gate value corresponding to the downscaled resolution, the intermediate prediction tensor being obtained by applying the prediction residual tensor to a downscale neural network.

7. The image decoding method of claim 4, wherein
a prediction residual tensor is obtained by subtracting the prediction tensor of the original resolution of the current image from the prediction image,
a prediction tensor of a resolution downscaled from the original resolution is determined from among the plurality of prediction tensors, based on an intermediate prediction tensor of the downscaled resolution and a remembering gate value corresponding to the downscaled resolution, the intermediate prediction tensor being obtained by applying the prediction residual tensor to a downscale neural network, and
a convolution kernel of a first layer of the downscale neural network is linearly mixed with a forgetting gate value corresponding to the original resolution.

8. The image decoding method of claim 1, wherein
a prediction residual tensor of a first downscaled resolution is obtained based on a subtraction tensor and a forgetting gate value corresponding to the first downscaled resolution, the subtraction tensor being obtained by subtracting a prediction tensor of the first downscaled resolution from an intermediate prediction tensor of the first downscaled resolution before applying a remembering gate value corresponding to the first downscaled resolution to a prediction tensor of the first downscaled resolution from among the plurality of prediction tensors, and
a prediction tensor of a second downscaled resolution obtained by downscaling the first downscaled resolution is determined from among the plurality of prediction tensors, based on an intermediate prediction tensor of the second downscaled resolution and a remembering gate value corresponding to the second downscaled resolution, the intermediate prediction tensor of the second downscaled resolution being obtained by applying the prediction residual tensor to a downscale neural network.

9. The image decoding method of claim 1, wherein
a prediction residual tensor of a first downscaled resolution is obtained based on a remembering gate value corresponding to the first downscaled resolution, a forgetting gate value corresponding to the first downscaled resolution, and an intermediate prediction tensor of the first downscaled resolution before applying the remembering gate value corresponding to the first downscaled resolution to the prediction tensor of the first downscaled resolution from among the plurality of prediction tensors, and
a prediction tensor of a second downscaled resolution obtained by downscaling the first downscaled resolution is determined from among the plurality of prediction tensors, based on an intermediate prediction tensor of the second downscaled resolution and a remembering gate value corresponding to the second downscaled resolution, the intermediate prediction tensor of the second downscaled resolution being obtained by applying the prediction residual tensor to a downscale neural network.

10. The image decoding method of claim 1, wherein
a prediction residual tensor of a first downscaled resolution is obtained by subtracting a prediction tensor of the first downscaled resolution from an intermediate prediction tensor of the first downscaled resolution before applying a remembering gate value corresponding to the first downscaled resolution to a prediction tensor of the first downscaled resolution from among the plurality of prediction tensors,
a prediction tensor of a second downscaled resolution obtained by downscaling the first downscaled resolution is determined from among the plurality of prediction tensors, based on an intermediate prediction tensor of the second downscaled resolution and a remembering gate value corresponding to the second downscaled resolution, the intermediate prediction tensor of the second downscaled resolution being obtained by applying the prediction residual tensor to a downscale neural network, and
a convolution kernel of a first layer of the downscale neural network is linearly mixed with a forgetting gate value corresponding to the first downscaled resolution.

11. The image decoding method of claim 5, wherein
the intermediate prediction tensor is additionally applied to the neural network-based second decoder based on a neural network to obtain the current reconstructed image.

12. An image encoding method comprising:
obtaining feature data of a current optical flow by applying a current image and a previous reconstructed image to a neural network-based first encoder;
obtaining, by applying the feature data of the current optical flow to a neural network-based first decoder, the current optical flow and a plurality of remembering gate values corresponding to a plurality of resolutions of the current image;
obtaining a prediction image of the current image from the previous reconstructed image, based on the current optical flow;
obtaining a plurality of prediction tensors corresponding to the plurality of resolutions, based on the prediction image and the plurality of remembering gate values;
obtaining feature data of a residual image by applying the plurality of prediction tensors and the current image to a neural network-based second encoder;
obtaining a current reconstructed image corresponding to the current image by applying the plurality of prediction tensors, the feature data of the current optical flow, and the feature data of the residual image to a neural network-based second decoder; and
generating a bitstream comprising the feature data of the current optical flow and the feature data of the residual image.

13. The image encoding method of claim 12, wherein
the plurality of remembering gate values represent values for maintaining information within the current image.

14. The image encoding method of claim 12, wherein
a plurality of forgetting gate values corresponding to the plurality of resolutions of the current image are additionally obtained from the neural network-based first decoder,
the plurality of prediction tensors are obtained based on the prediction image, the plurality of remembering gate values, and the plurality of forgetting gate values, and
the plurality of forgetting gate values represent values for removing, from the current image, a region in which a prediction error is equal to or greater than a preset value.

15. The image encoding method of claim 12, wherein
a prediction tensor of an original resolution of the current image from among the plurality of prediction tensors is determined based on the prediction image and a remembering gate value corresponding to the original resolution.
